(19) United States
(12) Patent Application Publication
(10) Pub. No.: US 2015/0287122 A1
(43) Pub. Date: Oct. 8, 2015

(54) CONSUMABLE PERSONALIZATION

(71) Applicant: White Shelf Research, LLC., San Francisco, CA (US)

(72) Inventor: Kenneth S. Mak, San Francisco, CA (US)

(21) Appl. No.: 14/681,927

(22) Filed: Apr. 8, 2015

Related U.S. Application Data
(60) Provisional application No. 61/977,018, filed on Apr. 8, 2014.

(51) Int. Cl. G06Q 30/06; G06F 3/0488; G06K 9/00; G06F 3/0484

(52) U.S. Cl. CPC G06Q 30/0631; G06F 3/0484; G06F 3/04883; G06K 9/00671; G06Q 30/0641

(57) ABSTRACT

Systems and methods for consumable personalization are provided. In example embodiments, a request to identify similar consumables that are similar to a first consumable is received from a user device of a user. Consumable data corresponding to a plurality of consumables is accessed. The consumable data includes attributes of respective consumables of the plurality of consumables. The attributes include potency data for a first active ingredient. A second consumable among the plurality of consumables is identified by comparing attributes of the first consumable with the attributes of the respective consumables of the plurality of consumables. The second consumable is presented on a user interface of the user device of the user.

### RELATED APPLICATIONS

This application claims the priority benefit, under 35 U.S.C. Section 119(e), to U.S. Provisional Application No. 61/977,018, entitled “CONSUMABLE PERSONALIZATION,” filed Apr. 8, 2014, which is hereby incorporated by reference in its entirety.

### TECHNICAL FIELD

Embodiments of the present disclosure relate generally to mobile computing technology and, more particularly, but not by way of limitation, to consumable personalization.

### BACKGROUND

An almost infinite variety of consumables such as wine, coffee, and cannabis are available to consumers. For instance, there are 738 documented cannabis strains as of this writing. In addition, there are up to 85 compounds found in cannabis. The differing attributes between the strains may range from subtle to profound. Conventionally, experienced connoisseurs make recommendations to consumers. However, each consumer has a unique physiology and preferences that may result in ill-advised recommendations even from experienced connoisseurs.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is a block diagram illustrating an example embodiment of a personalization system, according to some example embodiments.

FIG. 3 is a diagram illustrating an example of identifying a consumable using the personalization system, according to some example embodiments.

FIG. 4 is a flow diagram illustrating an example method for identifying a consumable similar to another consumable, according to some example embodiments.

FIGS. 5A and 5B are user interface diagrams depicting an example user interface for identifying a consumable, according to some example embodiments.

FIG. 6 is a flow diagram illustrating further example operations for identifying consumables similar to the first consumable, according to some example embodiments.

FIG. 7 is a flow diagram illustrating further example operations for identifying consumables similar to the first consumable, according to some example embodiments.

FIG. 8 is a flow diagram illustrating further operations for identifying consumables similar to the first consumable, according to some example embodiments.

FIG. 9 is a swim-lane diagram illustrating various communications between systems and devices performing a method for identifying a consumable, according to some example embodiments.

FIG. 10 is a flow diagram illustrating an example method for determining a consumption quantity for a second consumable based on attributes of the first consumable, according to some example embodiments.

FIGS. 11A, 11B, and 11C depict examples of user consumable potency data to determine a consumption quantity for a consumable, according to some example embodiments.

FIGS. 12-29 depict various example user interfaces and example devices, according to some example embodiments.

FIG. 30 is a block diagram illustrating an example of a software architecture that may be installed on a machine, according to some example embodiments.

FIG. 31 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example embodiments provide systems and methods for consumable personalization. The term “consumable,” as used herein, is intended to include a cannabis, wine, beer, chocolate, tea, coffee, and so forth. Each consumable can come in many different forms and variations. Each variation has different attributes that users experience differently. For consumables such as cannabis, a consumer's differing experience is beyond mere preference as different consumers can experience different psychoactive effects from the active ingredient. Identifying which consumable a consumer may prefer is a challenge given the vast variety available to choose from.

To assist users in identifying consumables, in various example embodiments, a personalization system receives a request to identify consumables similar to a first consumable. For example, a user may indicate a desire to find consumables that provide similar physical or psychoactive effects as the first consumable. After the personalization system receives the request to identify the similar consumables, the personalization system accesses consumable data corresponding to a plurality of consumables. The consumable data includes attributes of respective consumable of the plurality of consumables. The attributes include potency data for a first active ingredient of the first consumable. The personalization system identifies a second consumable among the plurality of consumables by comparing attributes of the first consumable with the attributes of the respective consumables. For instance, the personalization system can compare potencies of active ingredients or ratios of potencies of active ingredients in the consumables. After the personalization system identifies the second consumable, the personalization system causes presentation of the second consumable on a user interface of the user device.

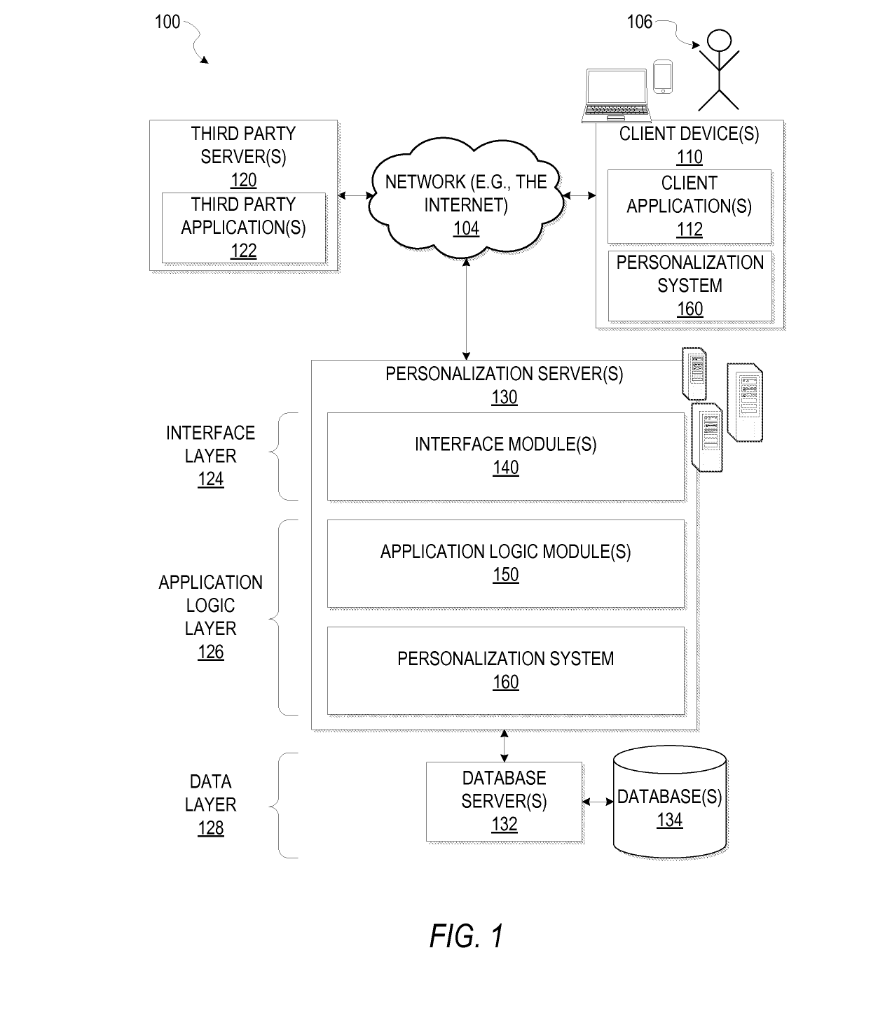

FIG. 1 is a network diagram depicting a network system 100 having a client-server architecture configured for exchanging data over a network, according to one embodiment. For example, the network system 100 may be a personalization and tracking system where clients communicate and exchange data within the network system 100. The data may pertain to various functions (e.g., sending and receiving text and media notifications, determining geolocation, etc.) and aspects (e.g., consumable personalization and tracking) associated with the network system 100 and its users. Although illustrated herein as client-server architecture, other embodiments may include other network architectures, such as peer-to-peer or distributed network environments.

As shown in FIG. 1, the network system 100 includes one or more personalization servers 130. The personalization servers 130 are generally based on a three-tiered architecture, comprising an interface layer 124, an application logic layer 126, and a data layer 128. As is understood by skilled artisans in the relevant computer and Internet-related arts, each module, system, or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. Of course, additional functional modules and engines may be used with a personalization and tracking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although the personalization servers 130 are depicted in FIG. 1 as a three-tiered architecture, the inventive subject matter is by no means limited to such an architecture.

As shown in FIG. 1, the interface layer 124 comprises interface module(s) (e.g., a web server) 140, which receive requests from various client-computing devices and servers, such as client device(s) 110 executing client application(s) 112, and third party server(s) 120 executing third party application(s) 122. In response to received requests, the interface module(s) 140 communicate appropriate responses to requesting devices via a network 104. For example, the interface module(s) 140 receive requests such as Hypertext Transfer Protocol (HTTP) requests or other web-based Application Programming Interface (API) requests.

The client device(s) 110 can execute conventional web browser applications or applications (also referred to as “apps”) that have been developed for a specific platform to include any of a wide variety of mobile computing devices and mobile-specific operating systems (e.g., IOS™, ANDROID™, WINDOWS® PHONE). In an example, the client device(s) 110 are executing the client application(s) 112. The client application(s) 112 can provide functionality to present information to a user 106 and communicate via the network 104 to exchange information with the personalization servers 130. Each of the client device(s) 110 can comprise a computing device that includes at least a display and communication capabilities with the network 104 to access the personalization servers 130. The client device(s) 110 comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. User(s) 106 can be a person, a machine, or other means of interacting with the client device(s) 110. In some embodiments, the user(s) 106 interact with the personalization servers 130 via the client device(s) 110.

As shown in FIG. 1, the data layer 128 has database server(s) 132 that facilitate access to information storage repositories or database(s) 134. The database(s) 134 are storage devices that store data such as user profile data (e.g., a user identification, user demographic information, user consumable data), and other user data.

The application logic layer 126 includes various application logic module(s) 150, which, in conjunction with the interface module(s) 140, generate various user interfaces with data retrieved from various data sources or data services in the data layer 128. Individual application logic module(s) 150 may be used to implement the functionality associated with various applications, services, and features of the personalization servers 130. For instance, a consumable personalization, tracking, and recommendation application can be implemented with one or more of the application logic module(s) 150. The application provides a data exchange mechanism for users of the client device(s) 110 to exchange consumable data (e.g., a history of consumable use by the user or recommended consumables for the user). Of course, other applications and services may be separately embodied in their own application server module(s) 150.

As illustrated in FIG. 1, the personalization servers 130 include a personalization system 160. In various embodiments, the personalization system 160 can be implemented as a standalone system and is not necessarily included in the personalization system 130. In some embodiments, the client device(s) 110 include a portion of the personalization system 160 (e.g., a portion of the personalization system 160 included independently or in the client application(s) 112). In embodiments where the client device(s) 110 includes a portion of the personalization system 160, the client device(s) 110 can work alone or in conjunction with the portion of the personalization system 160 included in a particular application server or included in the personalization servers 130.

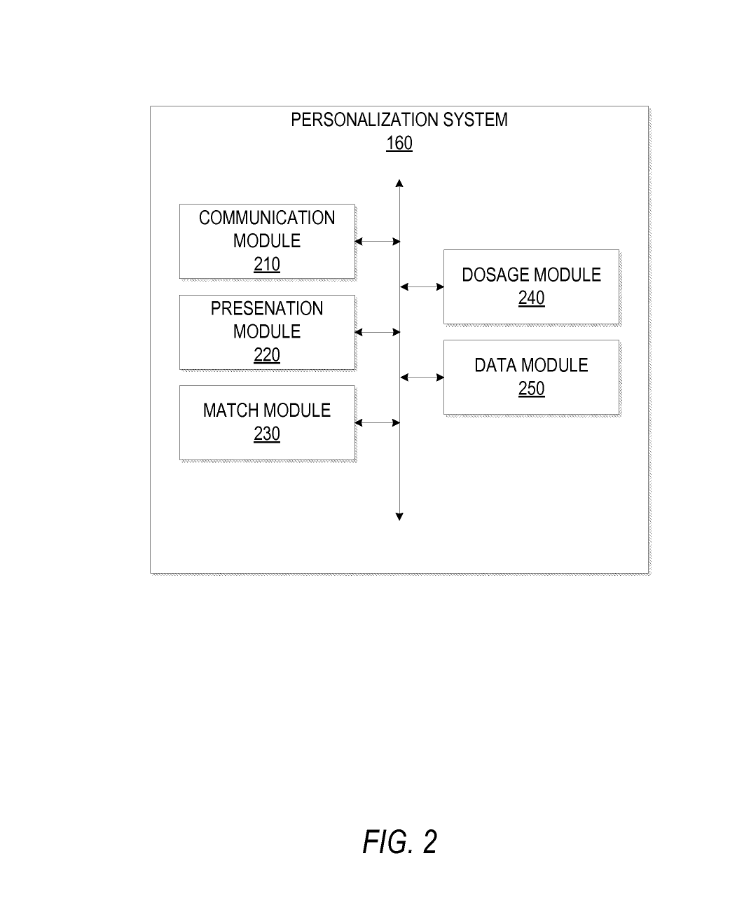

FIG. 2 is a block diagram 200 of the personalization system 160. The personalization system 160 is shown to include a communication module 210, a presentation module 220, a match module 230, a dosage module 240, and a data module 250. All or some of the modules 210-250 communicate with each other, for example, via a network coupling, bus, shared memory, and the like. Each module of the modules 210-250 can be implemented as a single module, combined into other modules, or further subdivided into multiple modules. Other modules not pertinent to example embodiments can also be included, but are not shown.

The communication module 210 provides various communications functionality. For example, the communication module 210 receives requests to identify consumables, preference selections from the user, user consumption data, and so forth. The communication module 210 exchanges network communications with the database server(s) 134, the client device(s) 110, and the third party server(s) 120. The information retrieved by the communication module 210 includes data associated with the user (e.g., a list of stored consumables for the user) or other data to facilitate the functionality described herein.

The presentation module 220 provides various presentation and user interface functionality operable to interactively present information to and receive information from the user. For instance, the presentation module 220 is utilizable to interactively present a list of identified consumables to the user. In various embodiments, the presentation module 220 presents or causes presentation of information (e.g., visually displaying information on a screen, acoustic output, haptic feedback). The process of interactively presenting information is intended to include the exchange of information between a particular device and the user. The user may provide input to interact with the user interface in many possible manners, such as alphanumeric, point based (e.g., cursor), tactile, or other input (e.g., touch screen, tactile sensor, light sensor, infrared sensor, biometric sensor, microphone, gyroscope, accelerometer, or other sensors). The presentation module 220 provides many other user interfaces to facilitate functionality described herein. The term “presenting” as used herein is intended to include communicating information or instructions to a particular device that is operable to perform presentation based on the communicated information or instructions.

The match module 230 provides functionality to identify consumables. For instance, the match module 230 identifies consumables based on a comparison of consumable attributes (e.g., active ingredient potency), user data (e.g., historical consumption logs, user preferences, or a user activity), or user data of another user (e.g., historical consumption logs of a particular user that is similar to the user).

The dosage module 240 provides functionality to determine consumption quantity recommendations. For example, the dosage module 240 performs an analysis of historical consumption data (e.g., a log of the user consumption sessions that includes consumable dosage data and a rating of the consumption session) to determine a recommended dose for a particular session. The dosage module 240 may account for a variety of factors when determining the recommended dose such as time of day, time of year, user activity, current weather, age of the consumable, potency of active ingredients in the consumable or similar consumables, and so forth. In another example, the dosage module 240 determines the recommended dosage or a recommended consumption quantity based on a previously consumption of another consumable. For instance, the dosage module 240 analyzes the concentrations or potencies of various compounds in the previously consumed consumable to determine a consumption quantity to achieve a recommended consumption quantity for a different consumable. The analysis module 240 may determine the recommended consumption quantity such that a similar physical or psychoactive effect results from the recommended consumption quantity for a particular consumable as compared with a previous consumption session.

The data module 250 provides various data functionality such as exchanging information with databases or servers. For example, the data module 250 accesses data from the third party server(s) 120, the database(s) 134, and the client device(s) 110. In a specific example, the data module 250 accesses consumable data corresponding to a plurality of consumables. The consumable data includes, for example, chemical composition data (e.g., active ingredient or passive ingredient potencies or concentrations), reviews, ratings, description, names, and so forth. In another example, the data module 250 accesses inventory data for a consumable from a particular third party server (e.g., an inventory level for a particular consumable at a particular dispensary or merchant). In further embodiments, the data module 250 tracks, or otherwise monitors, and stores consumption by the user. For example, the communication module 210 may receive consumption data of the user (e.g., a quantity consumed by the user during a consumption session). In a specific example, the data module 250 stores consumption data received from a scale (e.g., a smart scale communicatively coupled to the user device), or another detection device or sensor, that detects a consumption quantity of the consumable.

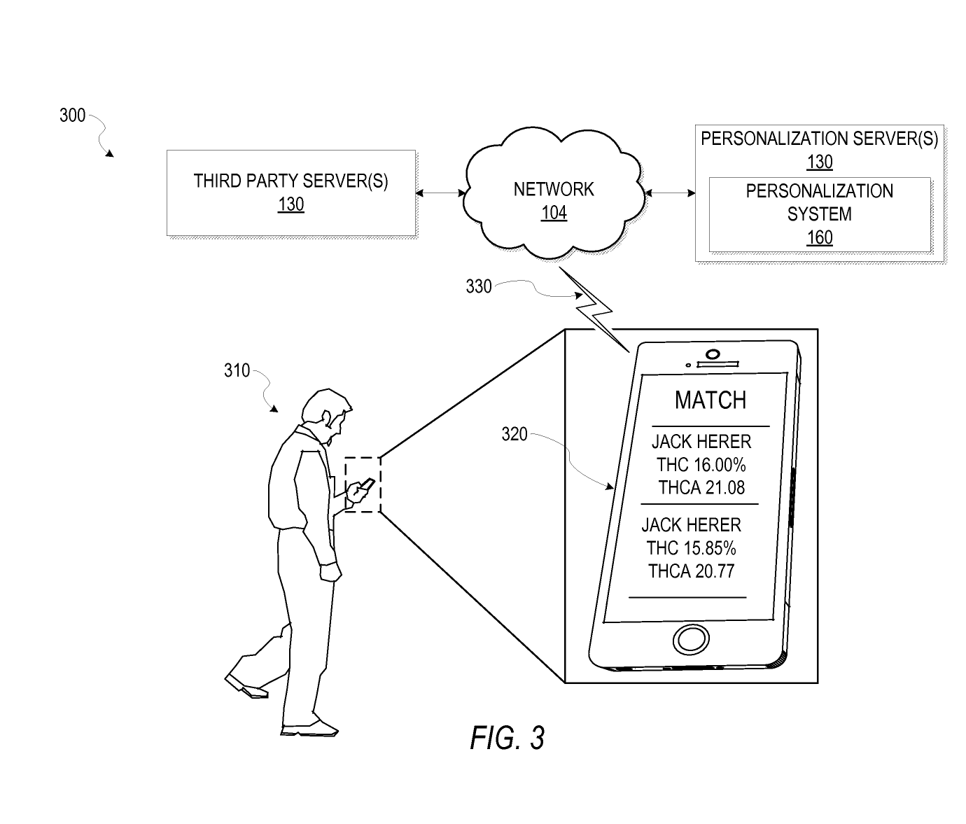

Turning now to FIG. 3, a diagram 300 illustrating an example of identifying a consumable using the personalization system 160 is shown. In the diagram 300, a user 310 is using a user device 320 that is displaying a user interface. The user device 320 is communicatively coupled to the network 104 and the personalization servers 130 via a communication link 330, allowing for an exchange of data between the personalization system 160, the third party servers 130, and the user device 320. In an example, the user device 320 is executing a consumable personalization application. The user 310 initiates a request to identify a consumable at the user device 320. In an example embodiment, the user device 320 can communicates the request to the personalization system 160 and the personalization system 160 responds to the request.

In some embodiments, the user device 320 is a location enable smart phone that can provide a current geolocation to the personalization system 160. In these embodiments, certain features of the personalization system are enabled, or activated, based on the current geolocation of the user. For example, government regulation for cannabis-based consumables differs by state. In various embodiments, some features of the personalization system 160 may be disable based on the current location being within a particular state.

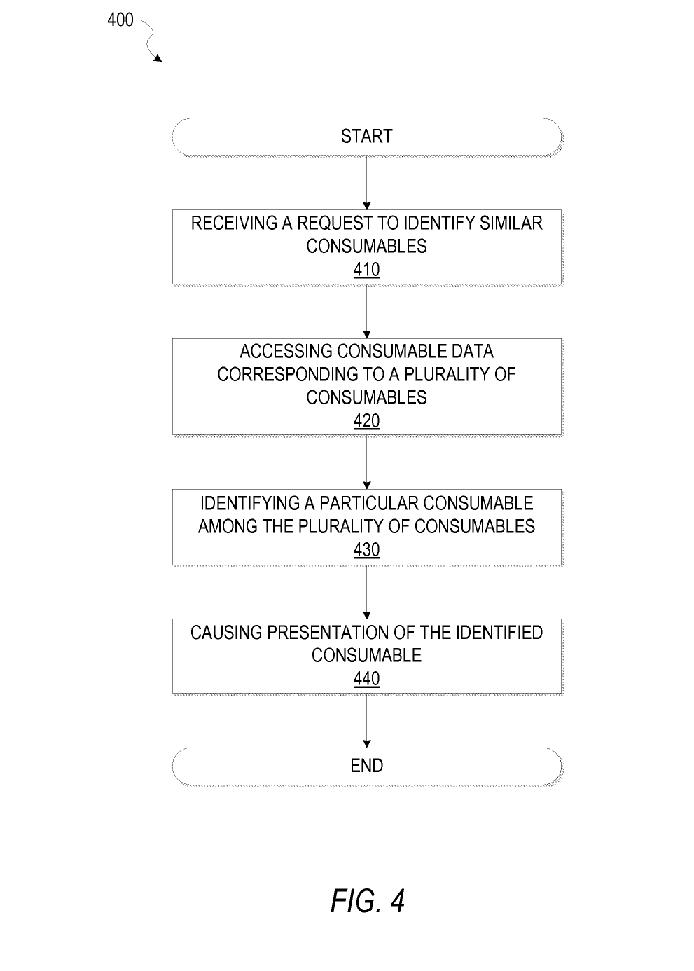

FIG. 4 is a flow diagram illustrating an example method for identifying a consumable similar to another consumable. The operations of method 400 can be performed by components of the personalization system 160, and are so described below for the purposes of illustration.

At operation 410, the communication module 210 receives, from a user device of a user, a request to identifying similar consumables that are similar to a first consumable. In some embodiments, the request includes consumable data corresponding to the first consumable such as a consumable identifier (e.g., a name), consumable description, chemical composition (e.g., active ingredient concentration), and so on.

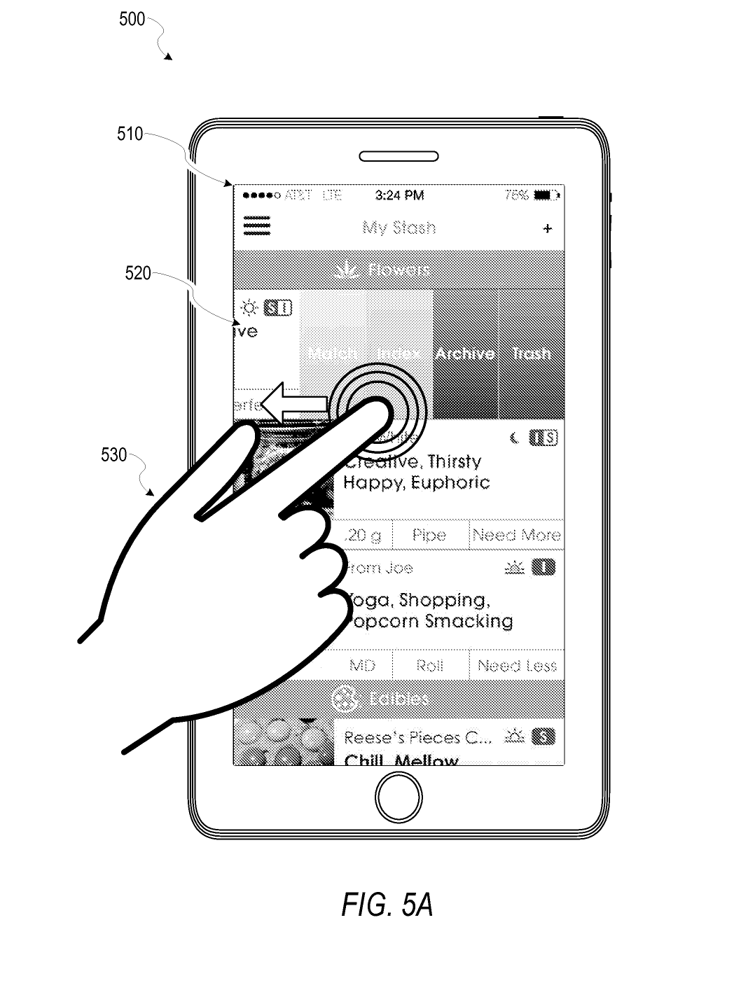

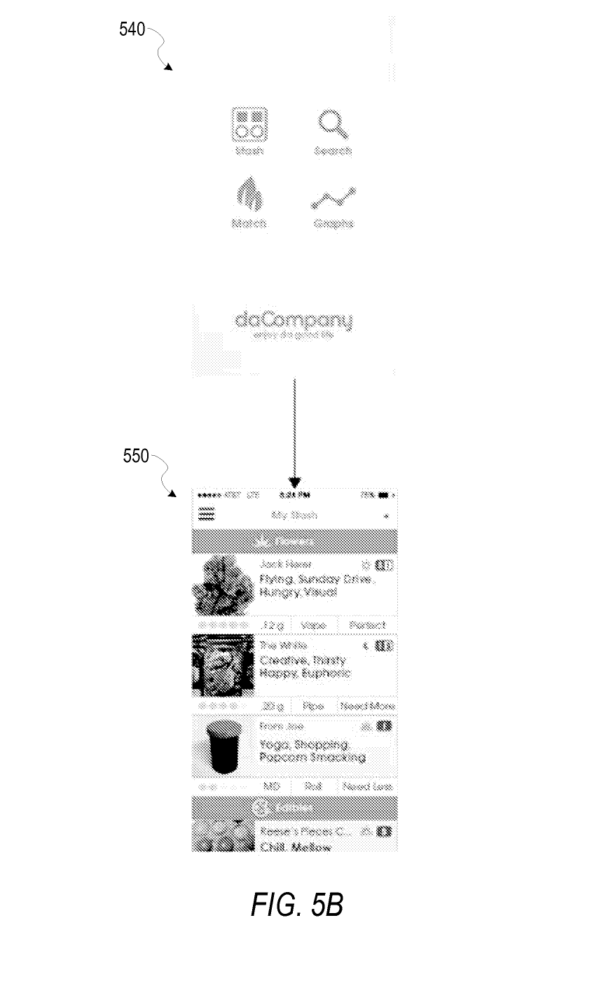

In an example embodiment, the user initiates the request at the user device and the request is received at the communication module 210. For example, the user can perform a touch-based gesture on the user device to initiate the request, as further discussed below in connection with FIGS. 5A and 5B. In another example, the user initiates the request with the user device scanning, or otherwise detecting, a particular consumable. For instance, the user device can include a camera, or another sensor, operable to detect an indication of the first consumable by Optical Character Recognition (OCR) or an automated identification technique such as Radio Frequency Identification (RFID) tags, Near Field Communication (NFC) smart, bar codes (e.g., one-dimensional bar codes such as Universal Product Code (UPC) bar codes, multi-dimensional bar codes such as a QR code, Aztec code, Data Matrix, Dataglyph, MaxiCode, PDF417, Ultra Code, Uniform Commercial Code Reduced Space Symbology (UCC RSS)-2D bar code, and other optical codes), or a suitable combination thereof. In a specific example, the user device detects the indication of the first consumable from packaging of the first consumable (e.g., OCR detection of a name of the first consumable label on packaging of the first consumable)

At operation 420, the data module 250 accesses consumable data corresponding to a plurality of consumables. In various embodiments, the consumable data includes attributes of respective consumables of the plurality of consumables. In these embodiments, the attributes include potency data for a first active ingredient. In further embodiments, the consumable data includes consumable descriptions, ratings, reviews, chemical composition, and other information. The data module 250 accesses the consumable data, for example, from the databases 134 or the third party servers 120.

At operation 430, the match module 230 identifies a second consumable, or multiple second consumables, among the plurality of consumables by comparing attributes of the first consumable with the attributes of the respective consumables of the plurality of consumables. In various embodiments, the attributes of consumables include, for example, chemical composition (e.g., active ingredients or a ratio of active ingredients), ratings or reviews, price, availability, name, description, an image of the consumable, and so forth. For example, the attribute of a particular consumable can comprise a chemical composition such as a concentration or potency of an active ingredient. In an example embodiment, the match module 230 scores candidate consumables among the plurality of consumables. For instance, if an attribute of the candidate consumable is the same or similar to the attribute of the first consumable, the candidate consumable may correspond to a higher score. In these embodiments, the match module 230 ranks the candidate consumables by their respective scores. In an embodiment, the match module 230 identifies the second consumable as being the highest scoring candidate consumable among the plurality of consumables. In another embodiment, the match module 230 identifies multiple matching second consumables (e.g., top 10 scoring candidate consumables).

At operation 440, the presentation module 220 causes presentation of the second consumable on a user interface of the user device. For example, the presentation module 220 causes presentation of data associated with the second consumable on the user device such as a consumable name, description, image, etc. In embodiments where the match module 230 identifies multiple consumables, the presentation module 220 can present a list of the identified multiple consumables (e.g., a list ranked by a score, alphabetically, or by consumable category).

In further example embodiments, the presentation module 220 converts an attribute description into a commonplace description. For example, scientific names for compounds can be translated or converted into “street names” or a common place name. To illustrate, a particular strain of cannabis or beer hops can contain myrcene, which is characterized by an earthy, fruity clove-like smell. The presentation module 220 can convert an attribute description that includes myrcene to a commonplace attribute description that includes, for example, earthy, fruity clove-like. In an example embodiment, the presentation module 220 accesses chemical composition data of a particular consumable, converts a scientific name included in the chemical composition data to a commonplace name, and causes presentation of the commonplace name on the user interface of the user device.

FIG. 5A is a user interface diagram 500 depicting an example user interface 510 for identifying a consumable. The user interface 510 includes a list of multiple consumables. For example, a list item 520 is a particular consumable in the list. In this example, the user is initiating a request to identify consumable similar to the consumable of the list item 520 by performing a touch-based gesture to reveal a menu that includes an option to “Match” the consumable of the list time 520. In an example embodiment, a user 530 can initiate the request to identified similar consumables using a touch-based gesture on the user device (e.g., a smart phone or another smart device with a touch-screen). In a specific example, the user can perform a touch-based gesture such as a swipe of the list item by moving the user's finger across the touch-screen, while in continuous contact with the touch-screen, in a horizontal motion on the touch-screen. That is to say, the user may initiate the request by moving their finger from left to right or right to left on the touch-screen within the bounds of the list item. In some embodiments, a menu is presented with an option to initiate the request in response to such a touch-based gesture (e.g., as shown by the list item 520 of FIG. 5A).

FIG. 5B shows user interface diagrams 540 and 550 depicting an example user interfaces for identifying a consumable. In an example embodiment, the user activates a user interface element of the user interface diagram 540 (e.g., tapping the “Match” button) to show the user interface show in the user interface diagram 550. Subsequently, the user can select a particular consumable from a list of consumables as shown in the user interface diagram 550. The communication module 210 receives an indication of the user specified consumable and the subsequent operations of FIG. 4 are performed.

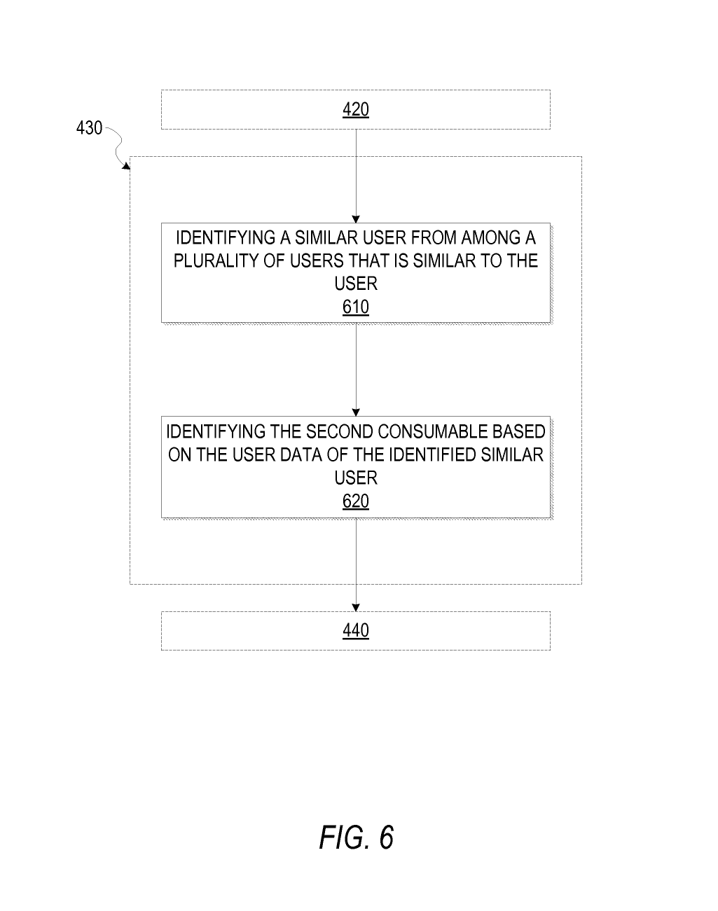

FIG. 6 is a flow diagram illustrating further example operations for identifying consumables similar to the first consumable. At operation 430, the match module 230 identifies the second consumable, or multiple second consumables, among the plurality of consumables. In some embodiments, the operation 430 includes the operations of FIG. 6.

At operation 610, the match module 230 identifies a similar user, or multiple similar users, from among a plurality of users that is similar to the user. In some embodiments, the match module 230 identifies the similar user based on user data of the user and user data of the similar user. In an example, the match module 230 identifies similar users of the user based on demographic information (e.g., same or similar age, socio-economic status, gender, marital status, or occupation) or other user information (e.g., medical conditions, user hobbies, user activities, consumable preferences, body weight, body height, or another physical characteristic of the user).

At operation 620, the match module 230 identifies the second consumable, or multiple second consumables, based on the user data of the identified similar user. In these embodiments, the user data includes consumable preference of the user (e.g., review, ratings, or notes pertaining to specific consumables), consumption log data (e.g., a number of time a particular user has used a particular consumable), and so forth.

In some embodiments, the match module 230 identifies the second consumable based on user data from multiple identified similar users. For example, the match module 230 can identify a first similar user that is similar to the user with respect to activities and hobbies and a second similar user that is similar to the user with respect to body size and physical activity level. In this example, the match module 230 can identify a consumable using the user data from the first similar user and the second similar user (e.g., identify a consumable with psychoactive affects based on the first similar user and with a potency of activity ingredients based on the second similar user).

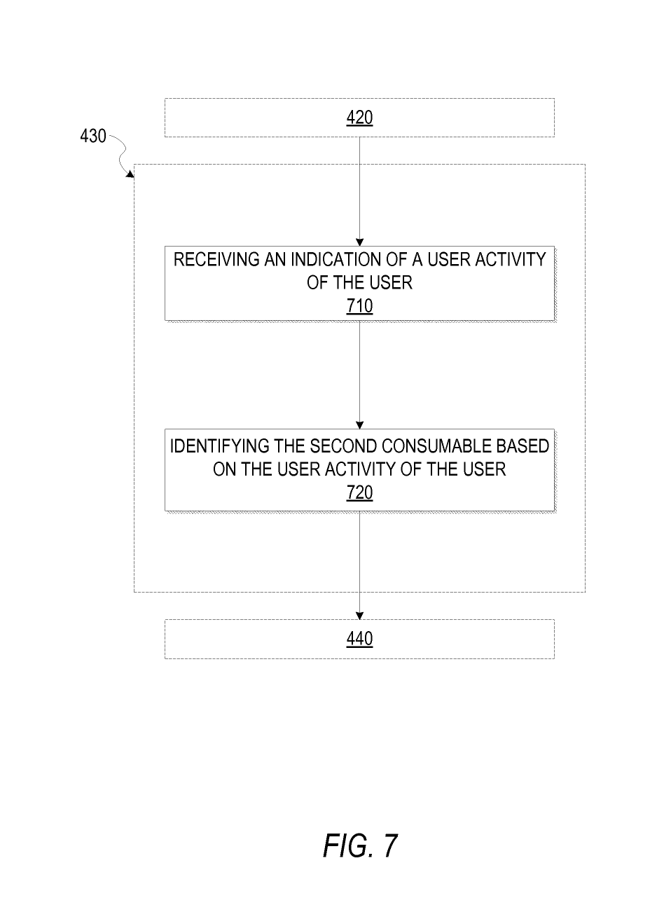

FIG. 7 is a flow diagram illustrating further example operations for identifying consumables similar to the first consumable. At operation 430, the match module 230 identifies the second consumable among the plurality of consumables. In some embodiments, the operation 430 includes the operations of FIG. 7.

At operation 710, the communication module 210 receives, from the user device, an indication of a user activity of the user. For example, the user may input or specify a user activity into the user device from a list of activities. In another example, the communication module 210 receives a current geolocation of the user (e.g., via a GPS component of the user device) and the match module 230 infers a user activity based on the current geolocation.

At operation 720, the match module 230 identifies the second consumable based, in part, on the user activity of the user. In an example embodiment, the match module 230 analyzes consumable data that includes consumption logs of a plurality of users. In an embodiment, the match module 230 can rank consumables with respect to a particular activity and identify a highest ranking consumable. For instance, if a particular consumable is frequently associated with a particular activity, the match module 230 may rank the particular consumable higher than another consumable that is less frequently associated with the particular activity.

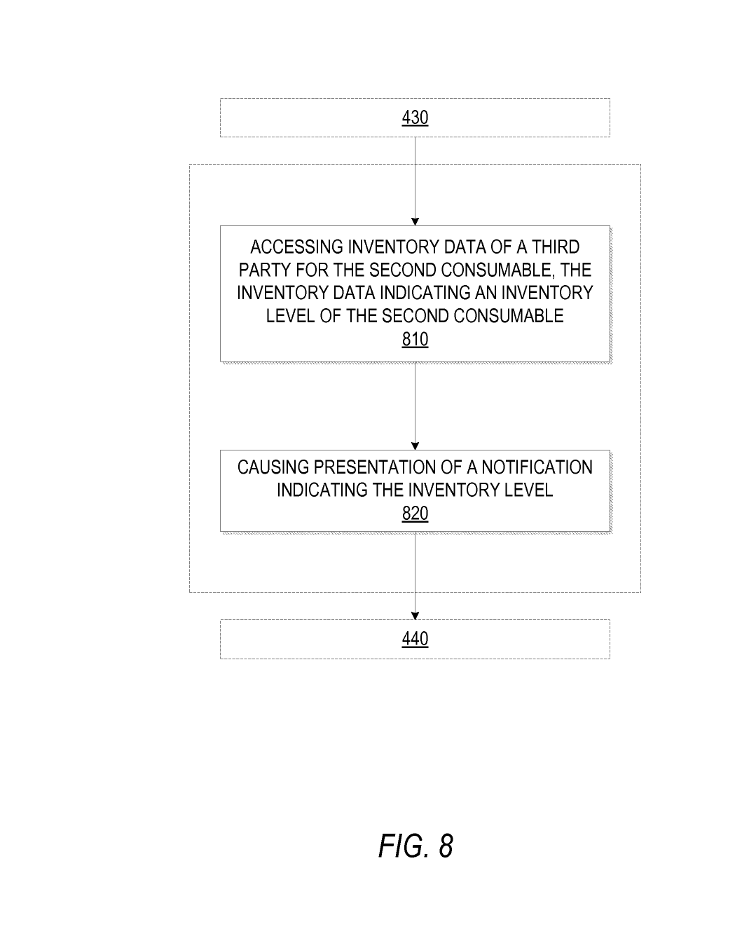

FIG. 8 is a flow diagram illustrating further example operations for identifying consumables similar to the first consumable. At operation 430, the match module 230 identifies the second consumable among the plurality of consumables. In some embodiments, subsequent to the operation 430, the operations of FIG. 8 are performed.

At operation 810, the data module 250 accesses inventory data of a third party for the second consumable from a third party server. The inventory data indicates an inventory level of the second consumable. In a specific example, the data module 250 identifies availability of the consumable to the user. For instance, the data module 250 may identify merchants or dispensaries that are within a radius of the user and access inventor data for the identified merchants. The inventory data indicates whether the particular consumable is in stock at the identified merchants.

At operation 820, the presentation module 220 causes presentation of a notification indicating the inventory level of the second consumable on the user interface of the user device. For instance, the presentation module 220 causes presentation of a local dispensary or merchant that has the second consumable in stock on the user device of the user.

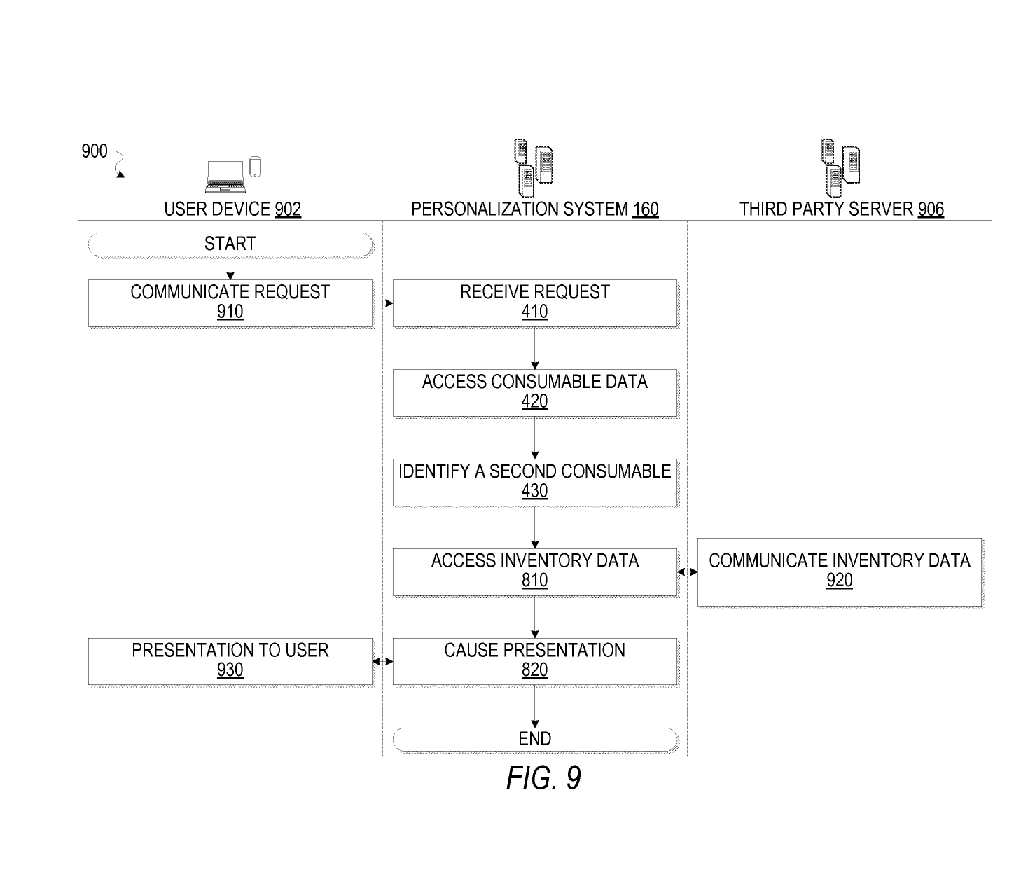

FIG. 9 is a swim-lane diagram illustrating various communications between systems and devices performing a method for identifying a consumable. At operation 910, user device 902 communicates a request to identify consumables to the personalization system 160. As described above, at the operation 410, the communication module 210 receives the request to identify the consumable, at the operation 420, the data module 250 accesses consumable data, and at the operation 430, the match module 230 identifies the second consumable.

Subsequent to the match module 230 identifying the second consumable, at the operation 810, the data module 250 accesses inventory data for the second consumable. The inventory data can be accessed from, for example, third party server 906. At operation 920, the third party servers communicate the inventory data to the communication module 210 and the data module 250. In some implementations, the inventory data is stored by the personalization system 160, for example, in the databases 134, and is periodically updated with queries to third party servers.

Once the inventory data is retrieved at the operation 810, at the operation 820, the presentation module 220 causes presentation the second consumable (e.g., consumable data associated with the second consumable) and the inventory data. For example, the presentation module 220 transmits the consumable data and the inventory data to the user device 902 and at operation 930, the user device presents the consumable data and the inventory data to the user.

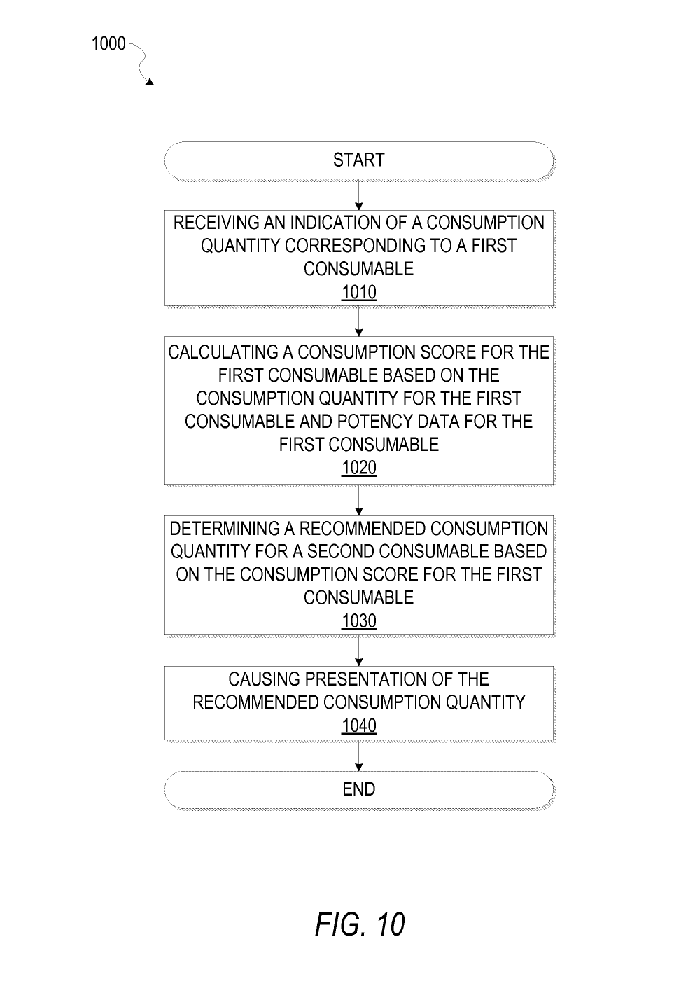

FIG. 10 is a flow diagram illustrating an example method for determining a consumption quantity for a second consumable based on attributes of the first consumable. The operations of method 1000 can be performed by components of the personalization system 160, and are so described below for the purposes of illustration.

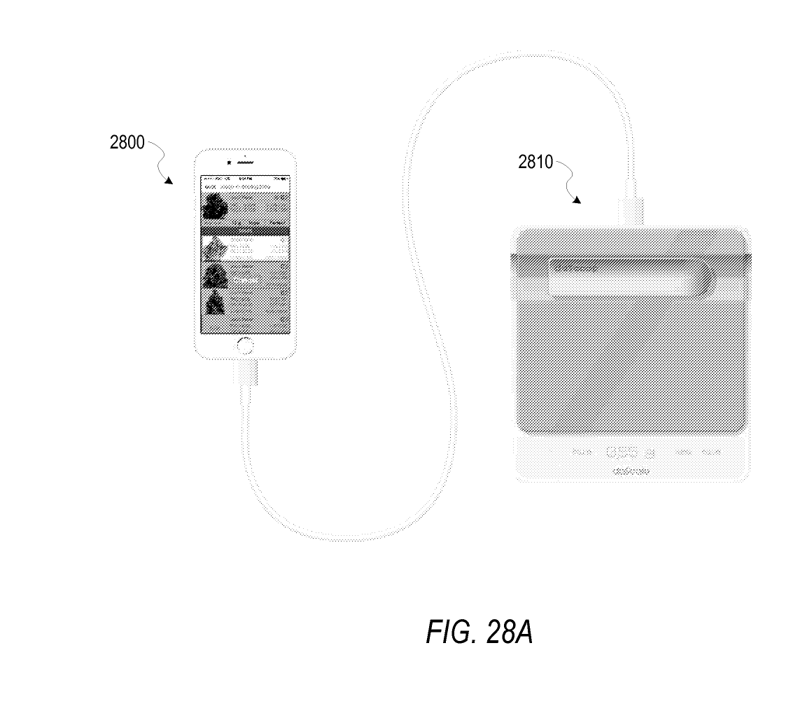

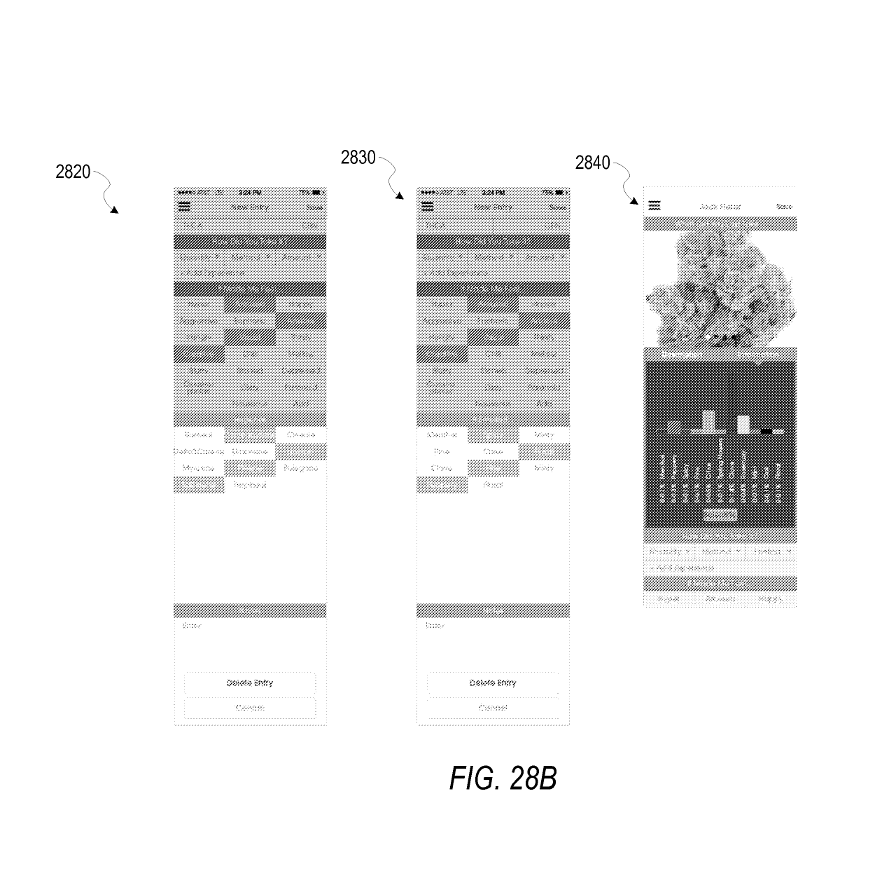

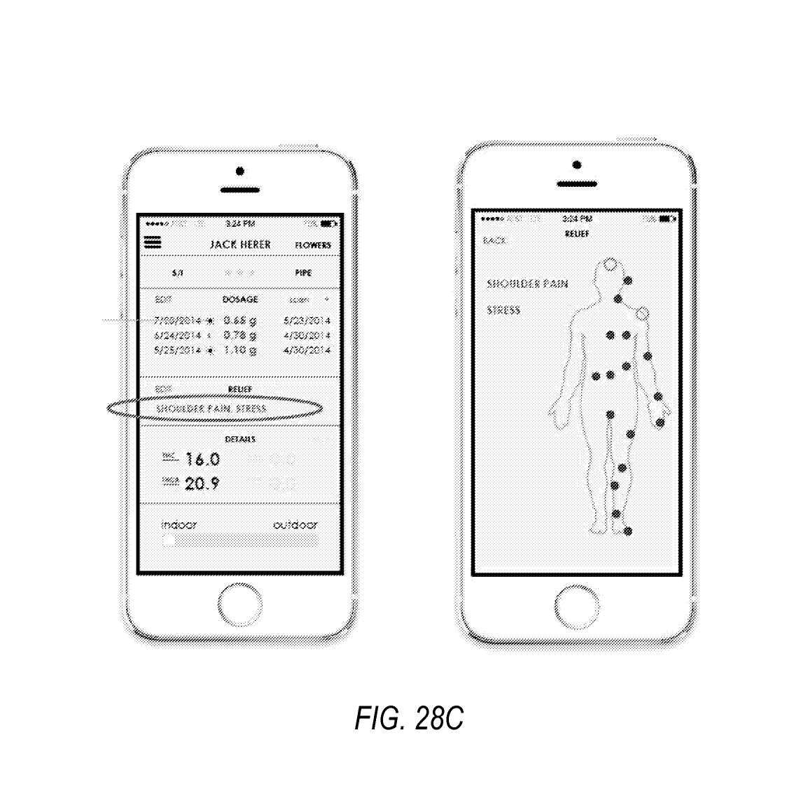

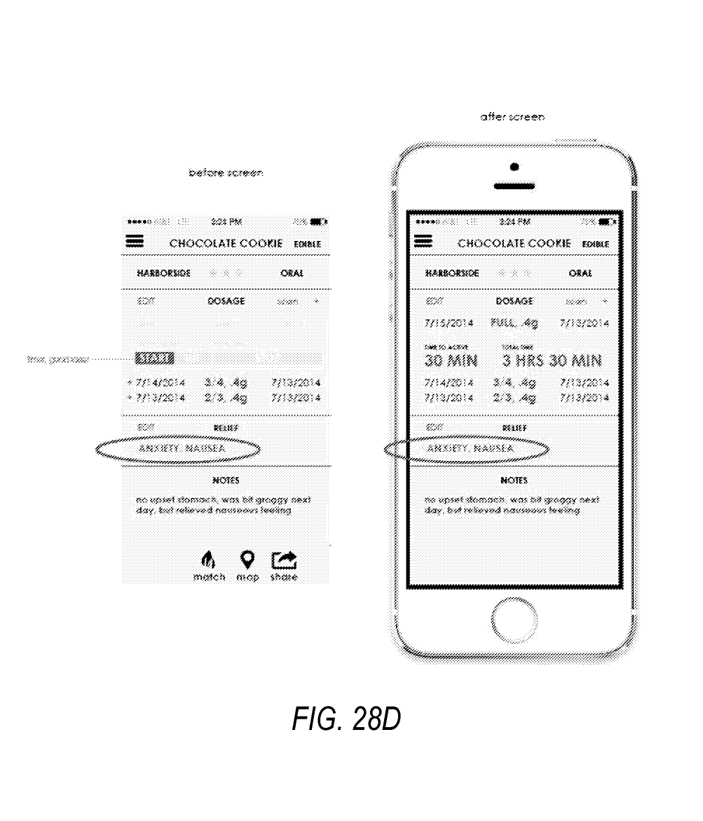

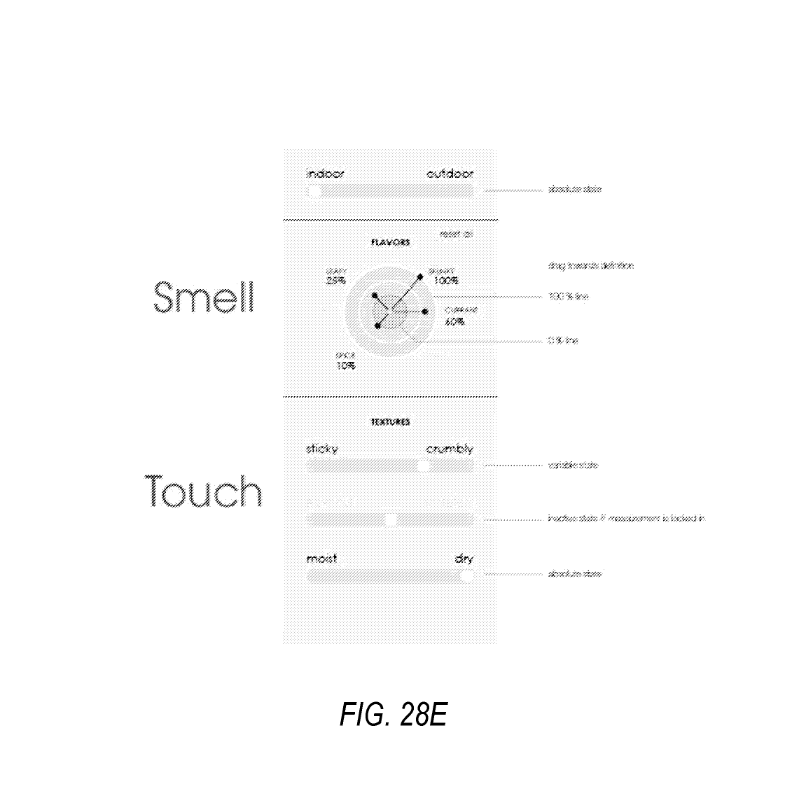

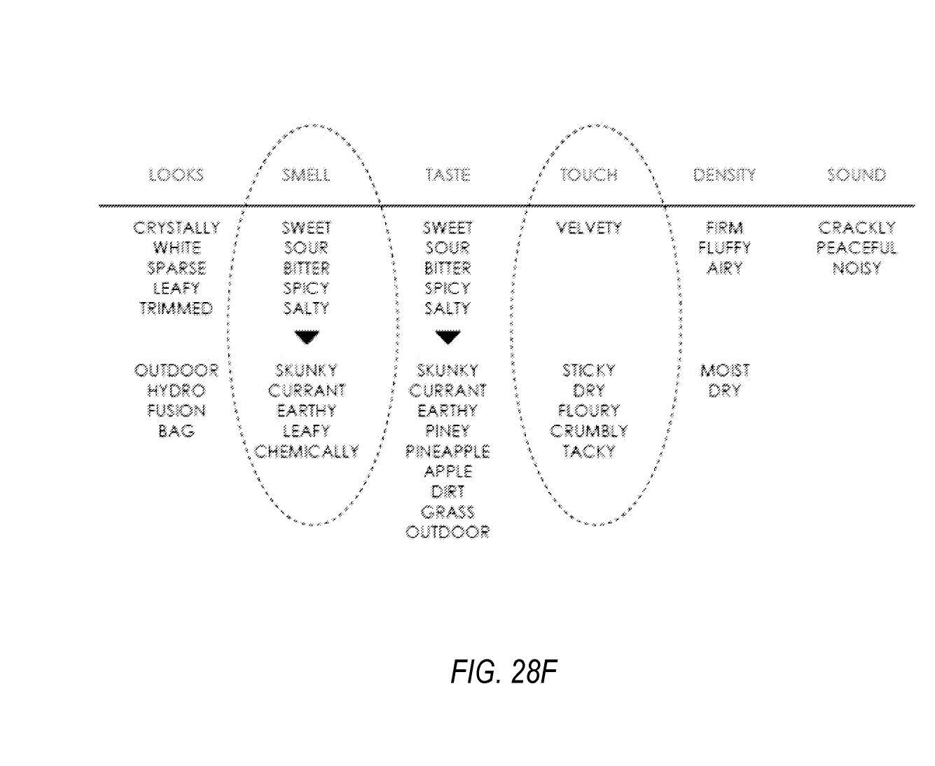

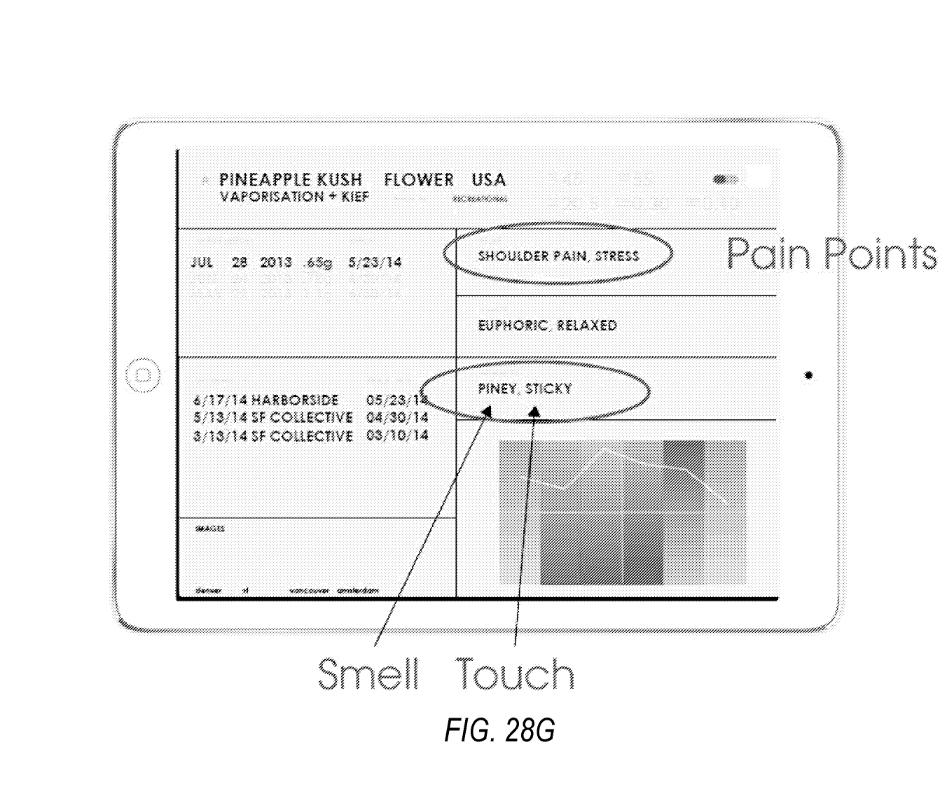

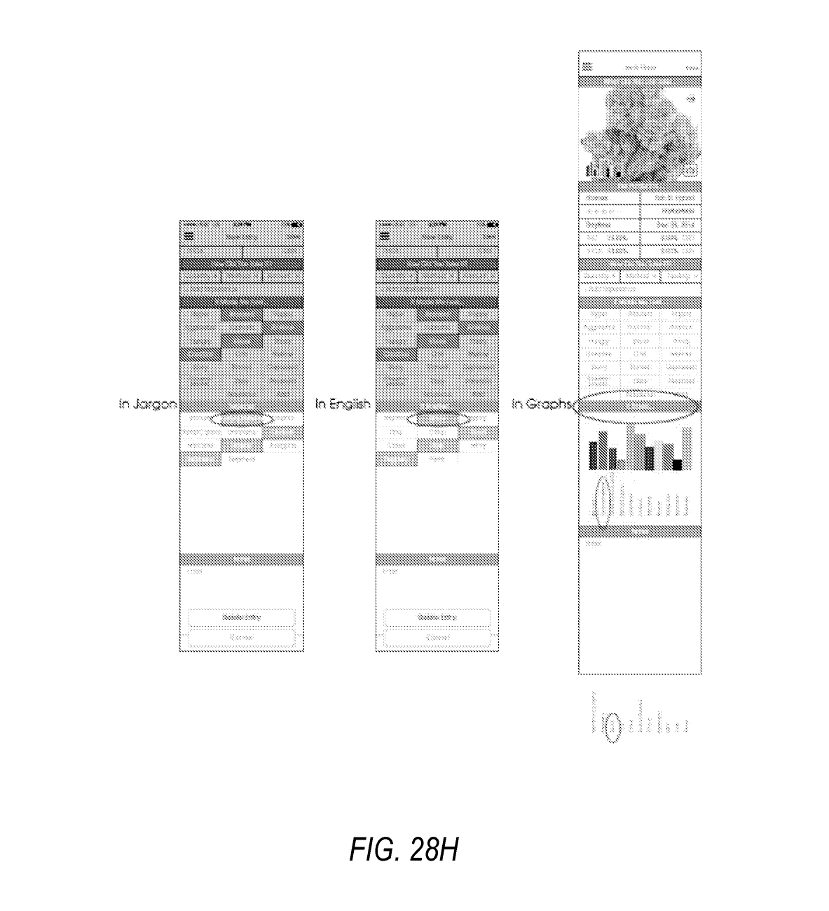

At operation 1010, the communication module 210 receives an indication of a consumption quantity corresponding to the first consumable from the user device. For example, the user can specify a particular consumption quantity (e.g., a number of grams consumed) of the first consumable into a user interface of the user device. In another example, the dosage module 240 determines a probably consumption quantity, such as an average consumption quantity, for the first consumable based on a consumption log data (e.g., a log that includes dosages for consumption sessions). In further embodiments, the indication of the consumption quantity is received from a measurement device (e.g., a connected or smart scale) that includes sensors operable to detect a consumption quantity (see FIG. 28A for an example).

At operation 1020, the dosage module 240 calculates a consumption score for the first consumable based on the consumption quantity corresponding to the first consumable and potency data for the first consumable. In an example embodiment, the dosage module 240 calculates the consumption score based on the consumption quantity and attributes of the first consumable. In a specific instance, the dosage module 240 computes the consumption score by multiplying the consumption quantity by a potency of a particular active ingredient in the first consumable. Where there are multiple active ingredients, the dosage module 240 can calculate the consumption score based on the multiple active ingredients. For example, if the consumable is cannabis, the dosage module 240 calculates the consumption score as the consumption quantity multiplied by a ratio of tetrahydrocannabinol (TCH) to cannabidiol (CBD).

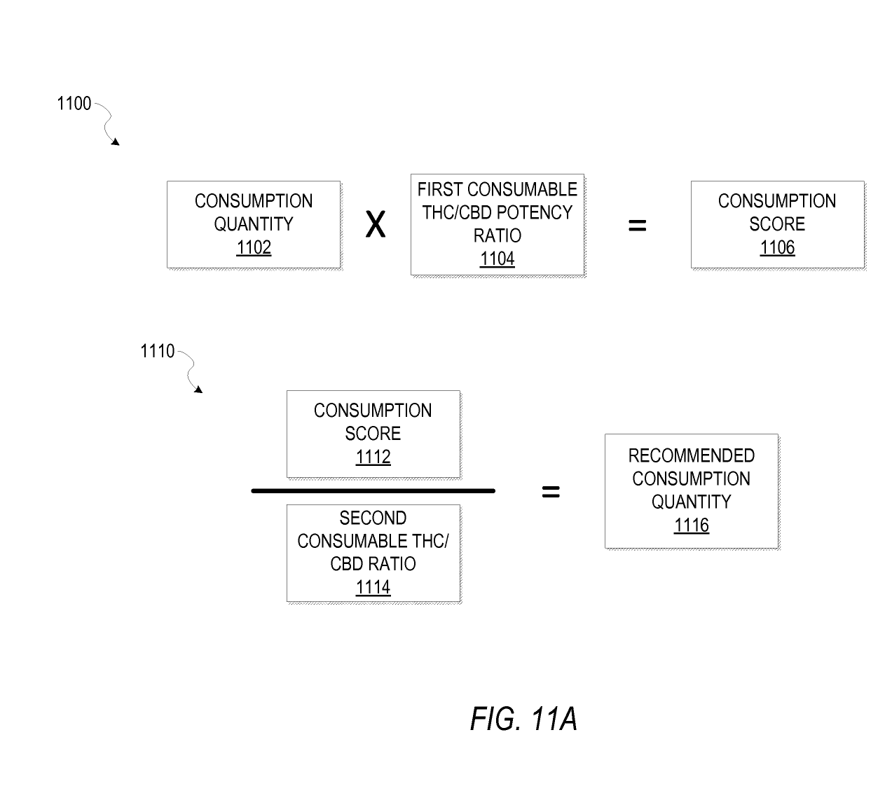

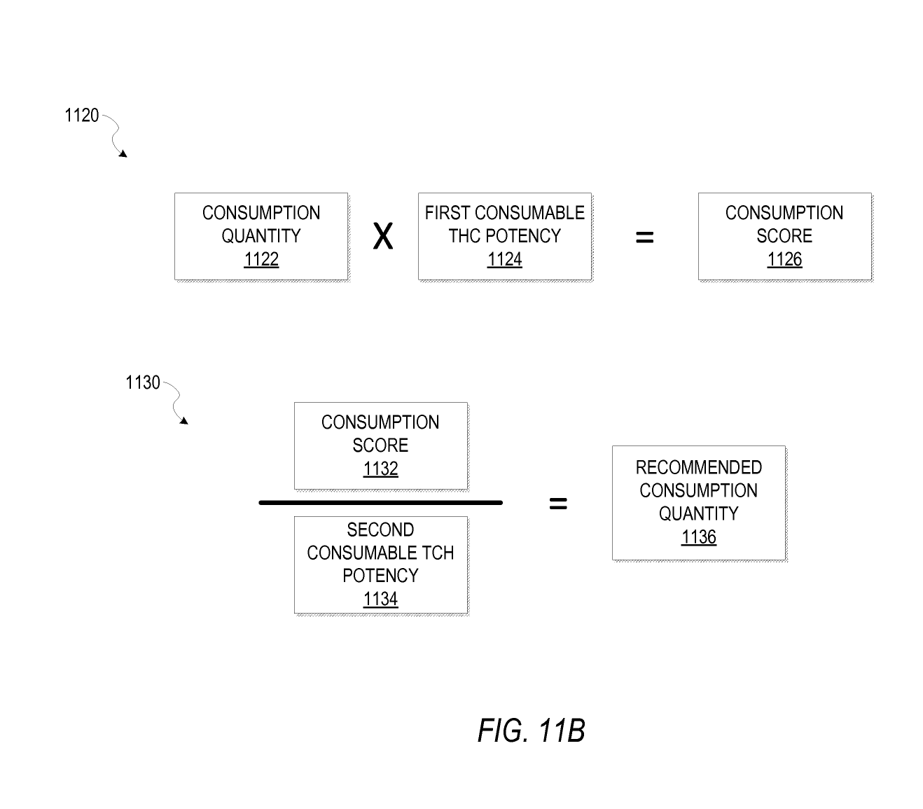

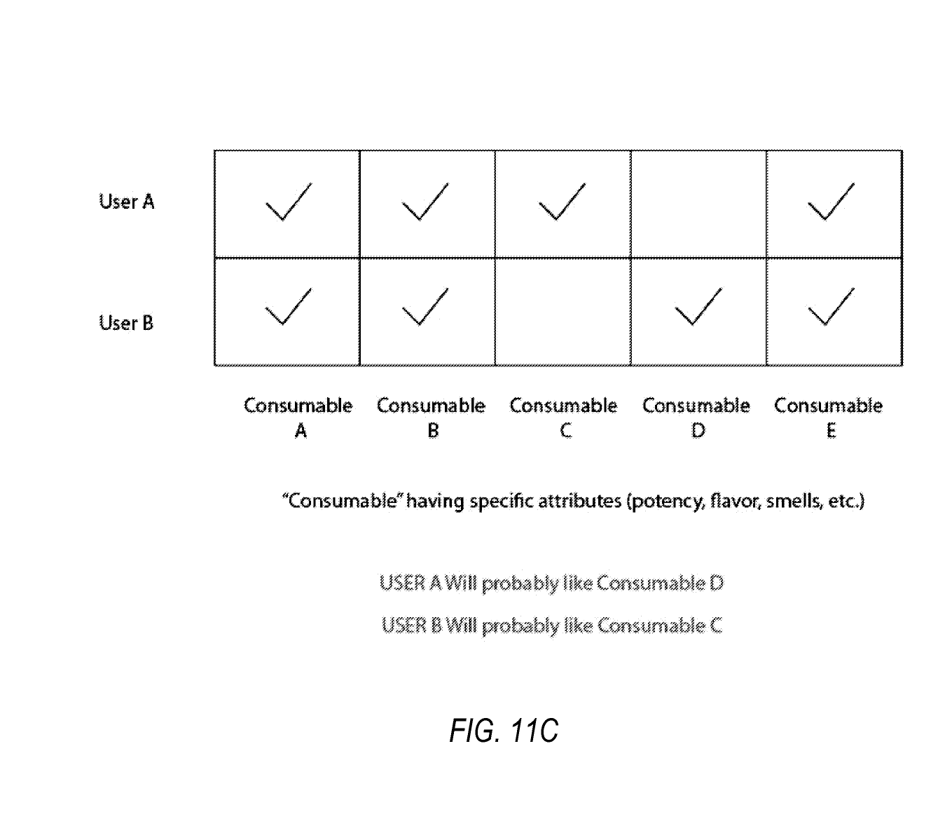

At operation 1030, the dosage module 240 determines a recommended consumption quantity for the second consumable based on the consumption score for the first consumable and potency data for the second consumable. In an example embodiment, when the dosage module 240 calculates the consumption score for the first consumable using a ratio of active ingredients, the dosage module 240 determines the recommended consumption quantity for the second consumable by calculating a ratio of active ingredients for the second consumable and then dividing the consumption score by the ratio of the second consumable as described below in connection with FIG. 11A. In another example, when the dosage module 240 calculates the consumption score for the first consumable using a concentration of a single active ingredient, the dosage module 240 determines the recommended consumption quantity for the second consumable by dividing the consumption score of the first consumable by the concentration of the single activity ingredient of the second consumable as described below in connection with FIG. 11B.

At operation 1040, the presentation module 220 causes presentation of the recommended consumption quantity to the user. For instance, the communication module 210 transmits the recommended consumption quantity for the second consumable to the user device and the user device presents the recommended consumption quantity on a display of the user device.

In some embodiments, the operations of FIG. 10 can be combined with the operations of FIG. 4. In an example embodiment, the operations of FIG. 10 can be performed in response to receiving the request at the operation 410. In this embodiment, the first consumable and the second consumable can be determined by the operations of the FIG. 4 and subsequently the operations of FIG. 10 are performed. In this way, the user can identify the second consumable and a recommended consumption quantity for the second consumable based on the first consumable.

FIGS. 11A and 11B depict examples of user consumable potency data used to determine a consumption quantity for a consumable. Diagram 1100 shows an example of calculating a consumption score 1106 from product THC/CBD potency ratio 1104 and consumption quantity 1102 of the first consumable. In the diagram 1100, the consumption score 1106 is calculated by multiplying the consumption quantity 1102 by the first consumable THC/CBD potency ratio 1104. Although a ratio of THC/CBD is shown, the dosage module 240 can employ other ratios or values derived from the chemical composition of the consumable to determine the consumption score.

Diagram 1110 shows an example for calculating a recommended consumption quantity 1116 from a consumption score 1112 (e.g., the consumption score 1106 discussed above) and second consumable THC/CBD ratio 1114. In the diagram 1110, the recommended consumption quantity 1116 is calculated by dividing the consumption score 1112 by the second consumable THC/CBD ratio 1114.

Diagram 1120 of FIG. 11B shows an example of calculating a consumption score 1126 from a consumption quantity 1122 and a THC potency 1124 of the first consumable. In the diagram 1120, the consumption score 1126 is calculated by multiplying the consumption quantity 1122 by the THC potency 1124.

Diagram 1130 shows an example for calculating a recommended consumption quantity 1136 from consumption score 1132 (e.g., the consumption score 1126 discussed above) and a second consumable THC potency 1134. In the diagram 1130, the recommended consumption quantity 1136 is calculated by dividing the consumption score 1132 by the second consumable THC potency 1134.

FIG. 11C is a diagram showing how the personalization system 160 can employ machine learning techniques to improve recommendations. For example, the personalization system 160 can analyze historical consumption logs of users and use machine learning techniques to predict preferences of certain users for certain consumables. In an embodiment, the personalization system 160 can employ AB testing to determine how well a particular consumable is matched to a particular user.

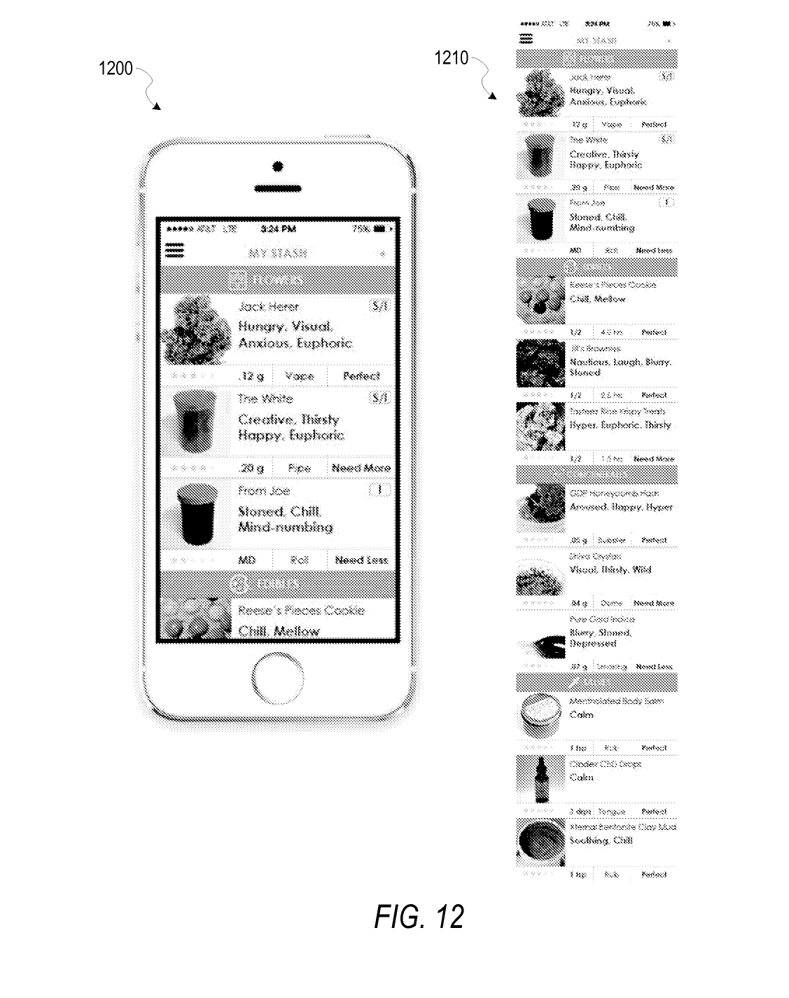

FIGS. 12-29 depict various example user interface and example devices, according to some example embodiments. Although FIGS. 12-29 depict specific example user interfaces and user interface elements, these are merely non-limiting examples; many other alternate user interfaces and user interface elements can be generated by the presentation module 210 and cause to be presented to the user. It will be noted that alternate presentations of the displays of FIGS. 12-29 can include additional information, graphics, options, and so forth. Alternatively, other presentations can include less information, or provide abridged information for easy use by the user.

FIG. 12 depicts example device 1200 (e.g., a smart phone) that is displaying example user interface (UI) 1210. The UI 1210 includes a list of consumables that the user may have inputted into the user device 1200. In the example of FIG. 12, the consumables in the list are categorized by consumable type (e.g., for cannabis-based products such as flowers, edibles, concentrates, and compounds). The UI 1210 also includes various consumable attributes, such as rating, a name, a recommended dosage or consumption quantity, a delivery type, and so forth. In some embodiments, the rating is a composite of multiple user ratings for the particular consumable. In other embodiments, the rating is the rating of the user. In still other embodiments, the rating is a composite of multiple user ratings for users that are similar to the user (e.g., similar demographic information, similar body type, similar consumable preferences).

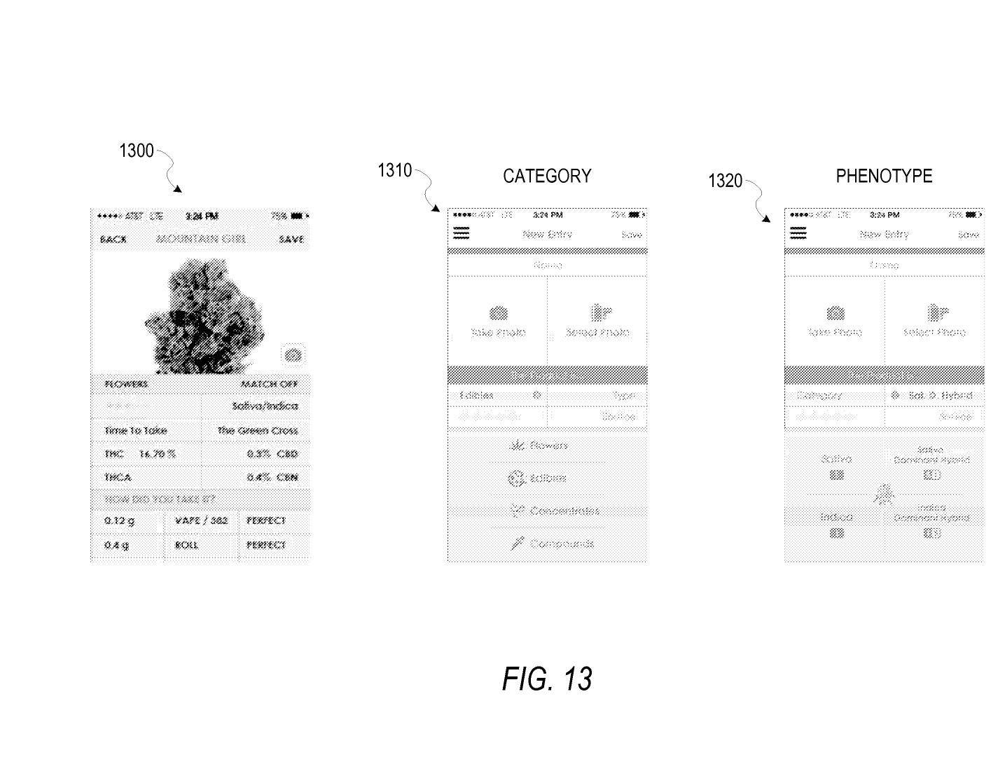

FIG. 13 depicts example UIs 1300, 1310, and 1320. The UI 1300 shows detailed attribute data for a particular consumable. For instance, the attribute data included in the UI 1300 includes active ingredient potency data (e.g., THC or CBD potency for cannabis-based products). In addition, the UI 1300 includes specific information that the user may have specified such as a particular experience with the particular consumable (e.g., dosage, delivery method, and a subjective indication of overall experience with the particular consumption session).

The UI 1310 and 1320 provides the user with user interface elements to input information pertaining to a particular consumable. In the UI 1310, the user can specify a category for a particular consumable such as flowers, edibles, concentrates, or compounds. In the UI 1320, the user can specify a phenotype for the consumable such as sativa, sativa dominant hybrid, indica, or indica dominant hybrid.

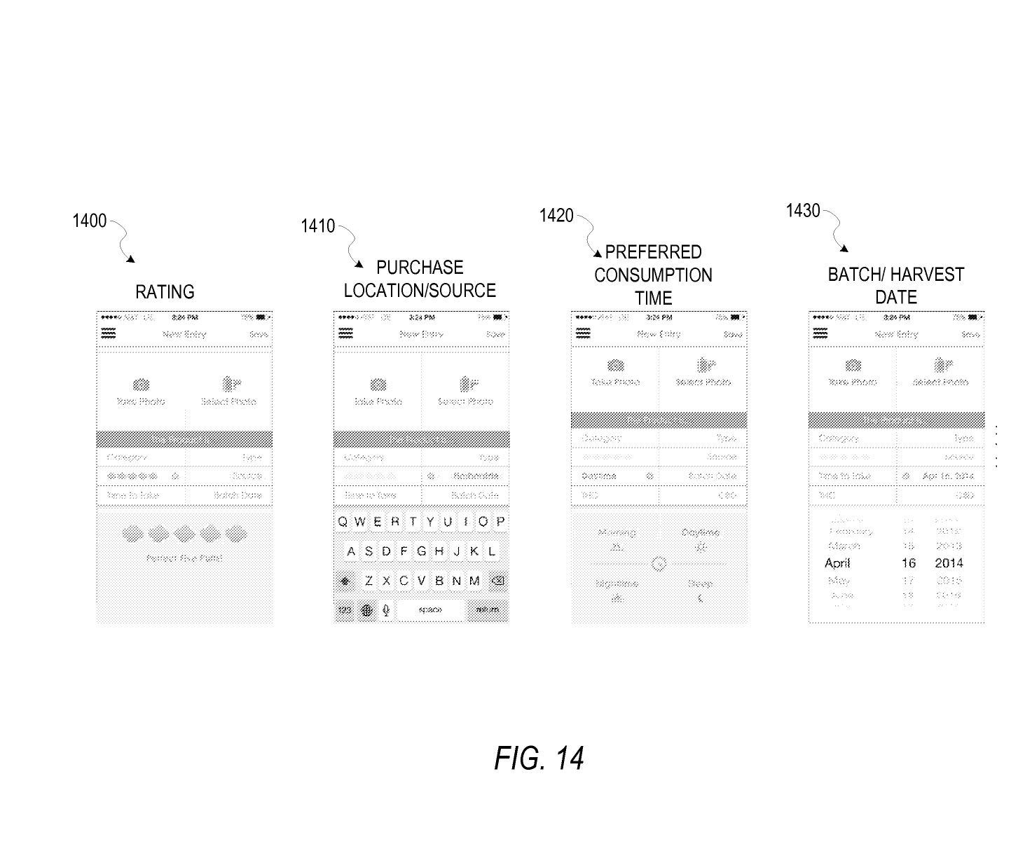

FIG. 14 depicts example UIs 1400, 1410, 1420, and 1430. Using these user interfaces, the user can specify preferences, ratings, and other consumable data. For example, the UI 1400 is configured to receive rating data for a particular consumable such as a numerical rating ranging from 0 to 5. The UI 1410 is configured to receive source consumable data that indicates a source of a particular consumable such as a particular merchant where the particular consumable originated. The UI 1420 is configured to receive a preferred consumption time associated with a particular consumable. The UI 1430 is configured to receive a batch or harvest date for a particular consumable. For certain consumables, such a date may affect potency values for active ingredients described above since decay of the consumable over time can decrease potency of certain compounds.

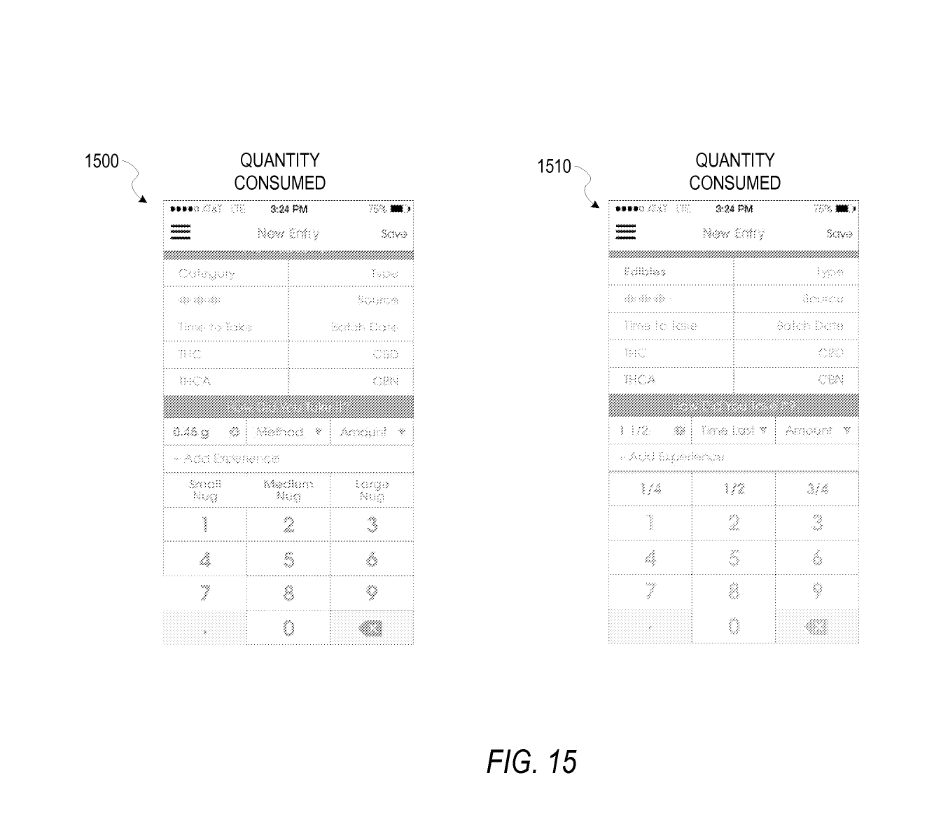

FIG. 15 depicts example UIs 1500 and 1510. Using these user interfaces, the user can specify a quantity consumed. In other embodiments, the quantity consumed is automatically provided to the personalization system via a device (e.g., a connected scale) communicatively coupled to the user device or the personalization system 160.

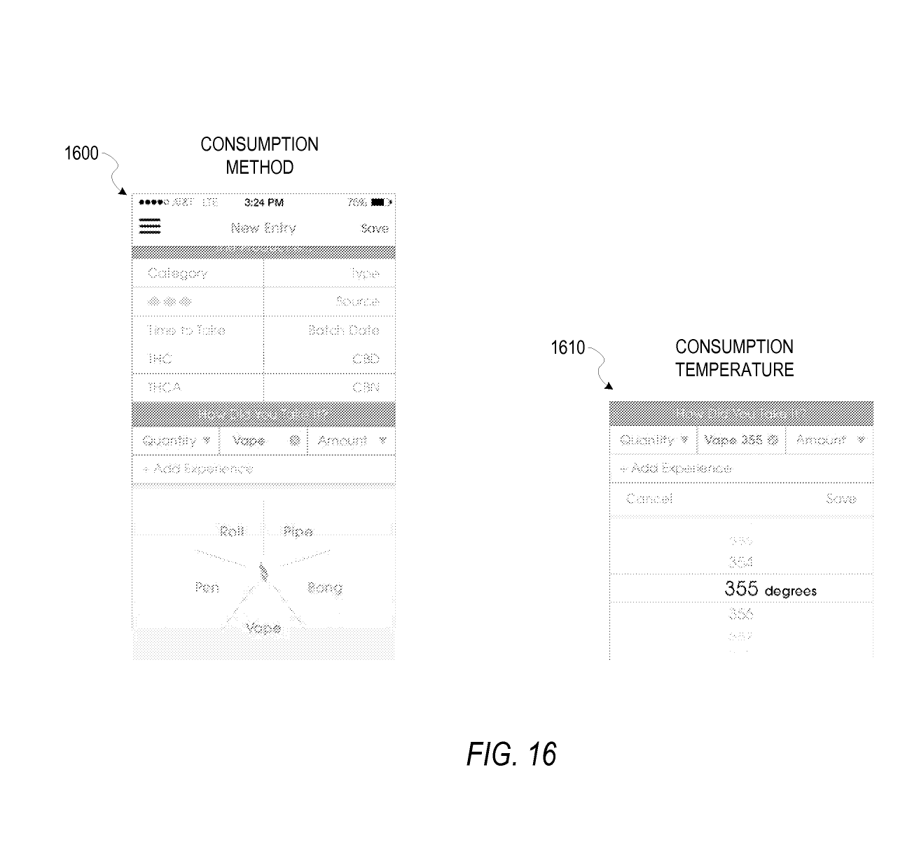

FIG. 16 depicts example UIs 1600 and 1610. Using these user interfaces, the user can specify a consumption method (e.g., roll, pen, pipe, bong, or vape for cannabis-based consumables) and details regarding the consumption method such as burn temperature for vaporized consumption of cannabis.

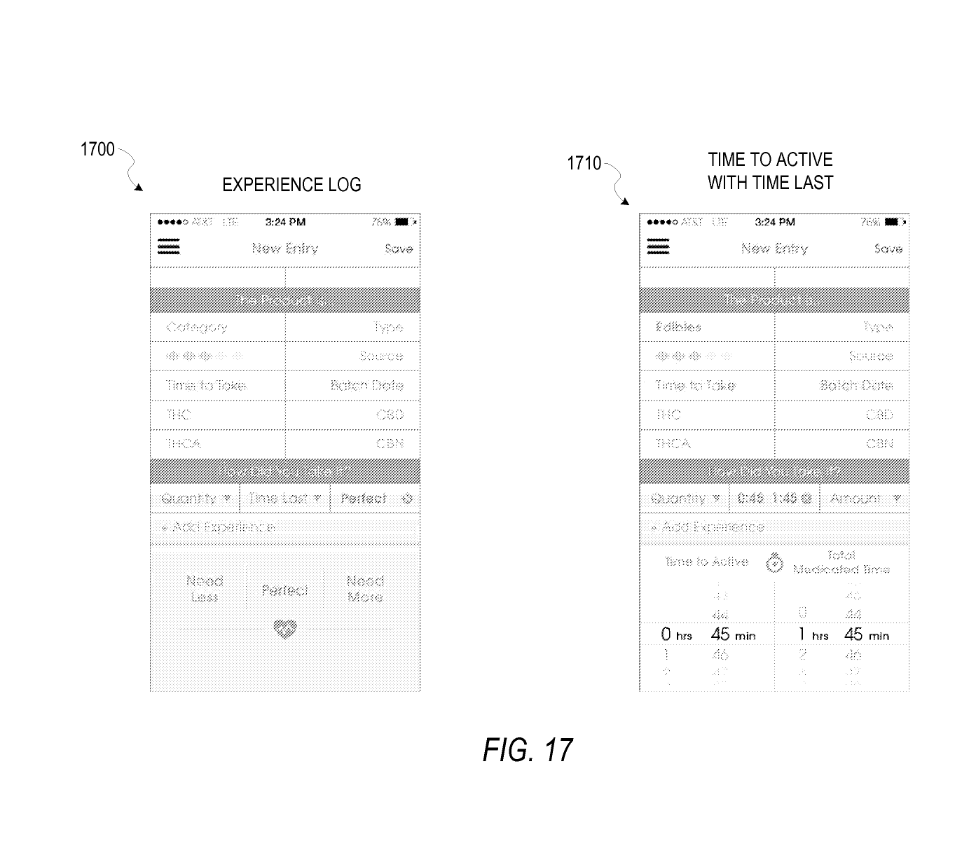

FIG. 17 depicts example UIs 1700 and 1710. Using these user interfaces, the user can provide consumable data such as subjective and objective information about a particular consumption session.

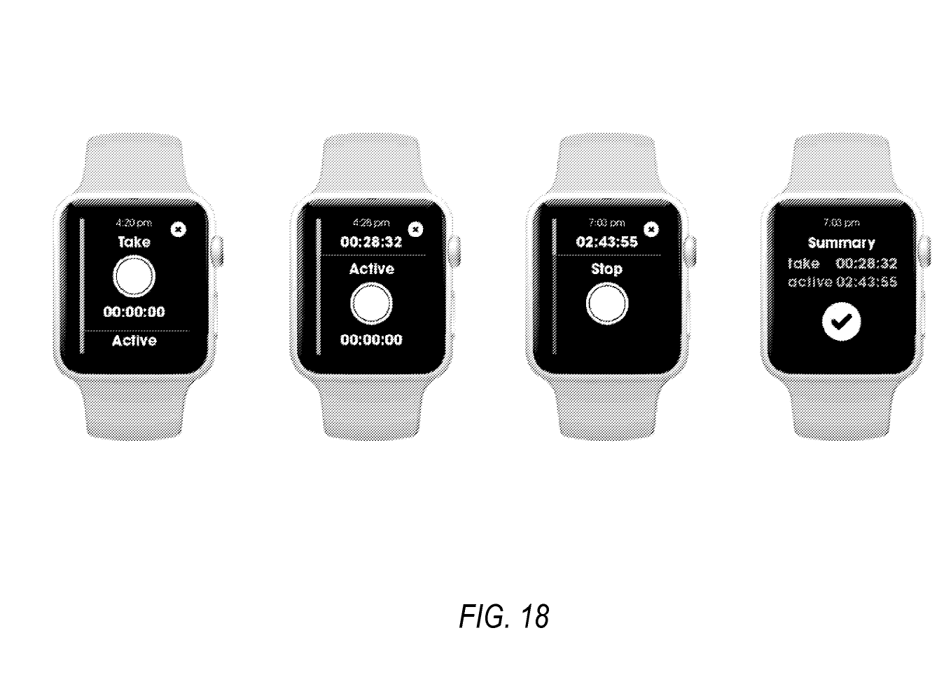

FIG. 18 depicts example smart devices that the user can user to log, track, or otherwise monitor consumption sessions. For instance, the smart device may comprise a smart watch equipped with biometric sensors to detect biosignals of the user during a consumption session. In another instance, the user can track a length of time a particular effect of the consumable lasts to assist in determining future dosages of the consumable.

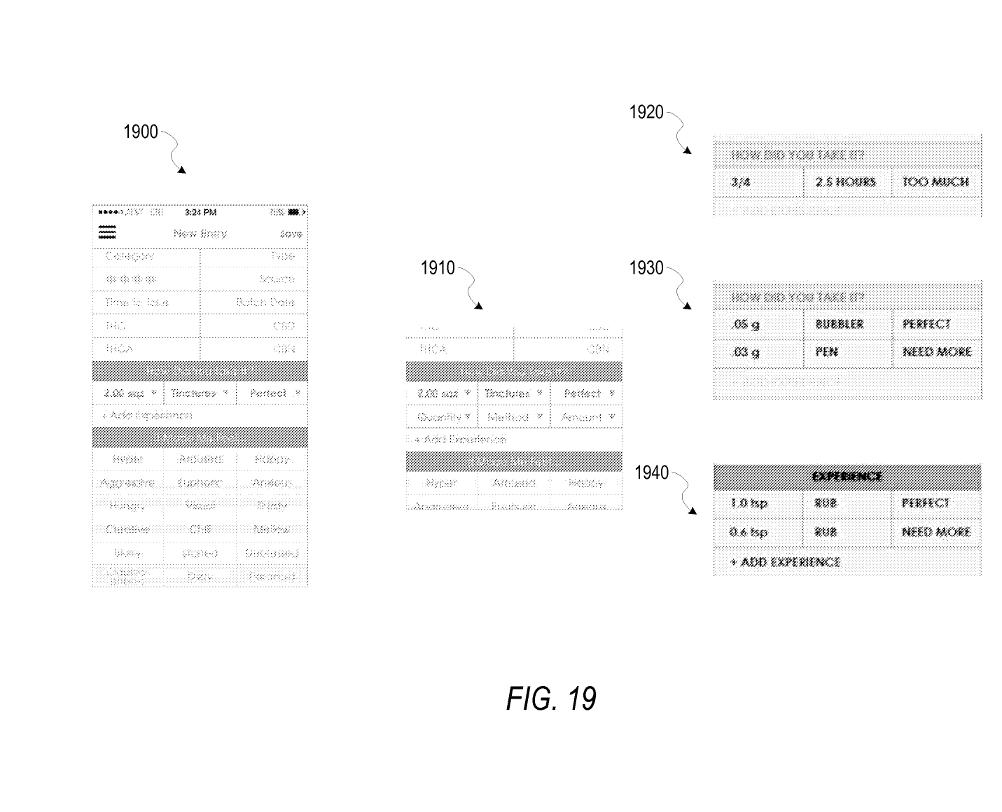

FIG. 19 depicts example UIs 1900, 1910, 1920, 1930, and 1940. The user can provide information pertaining to a particular consumption session using these UIs. For instance, the user can indicate a particular feeling associated with the consumption session such as hyper, aroused, happy, aggressive, euphoric, anxious, hungry, visual, thirsty, creative, chill, mellow, blurry, stoned, depressed, claustrophobic, dizzy, paranoid, and so forth. In addition, the user can provide information in free form such as notes about the experience. In various embodiments, the notes and consumption log information can remain private to the user (e.g., not accessible to other users), accessible to other users anonymously, or publicly accessible to all users.

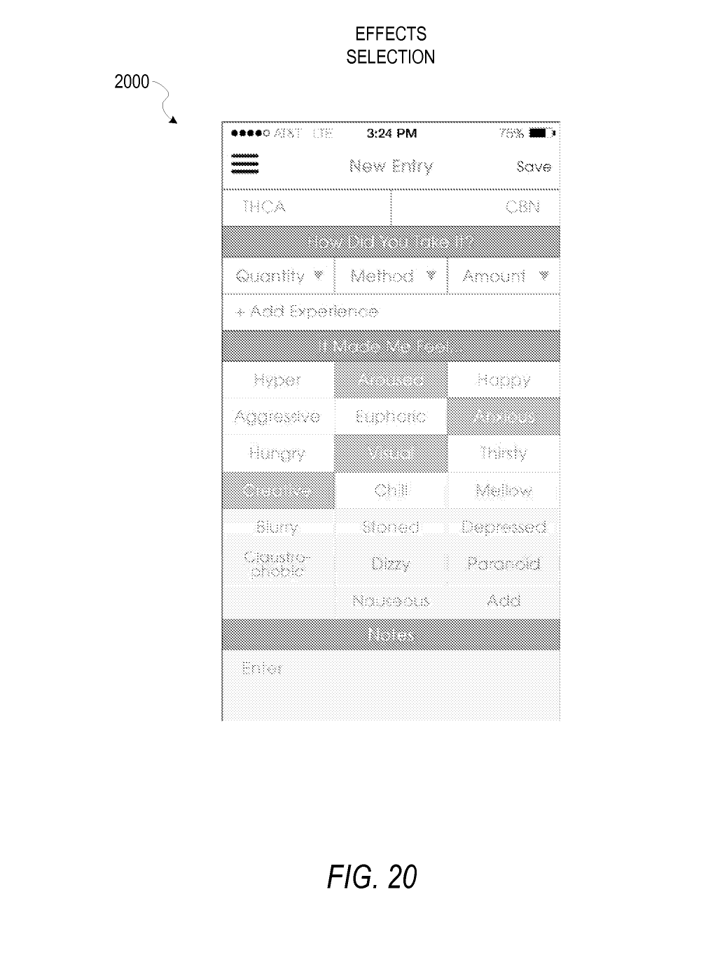

FIG. 20 depicts example UI 2000. UI 2000 shows and example entry for a particular consumption session. In this example entry, the user indicated the consumption session as feeling aroused, anxious, visual, and creative.

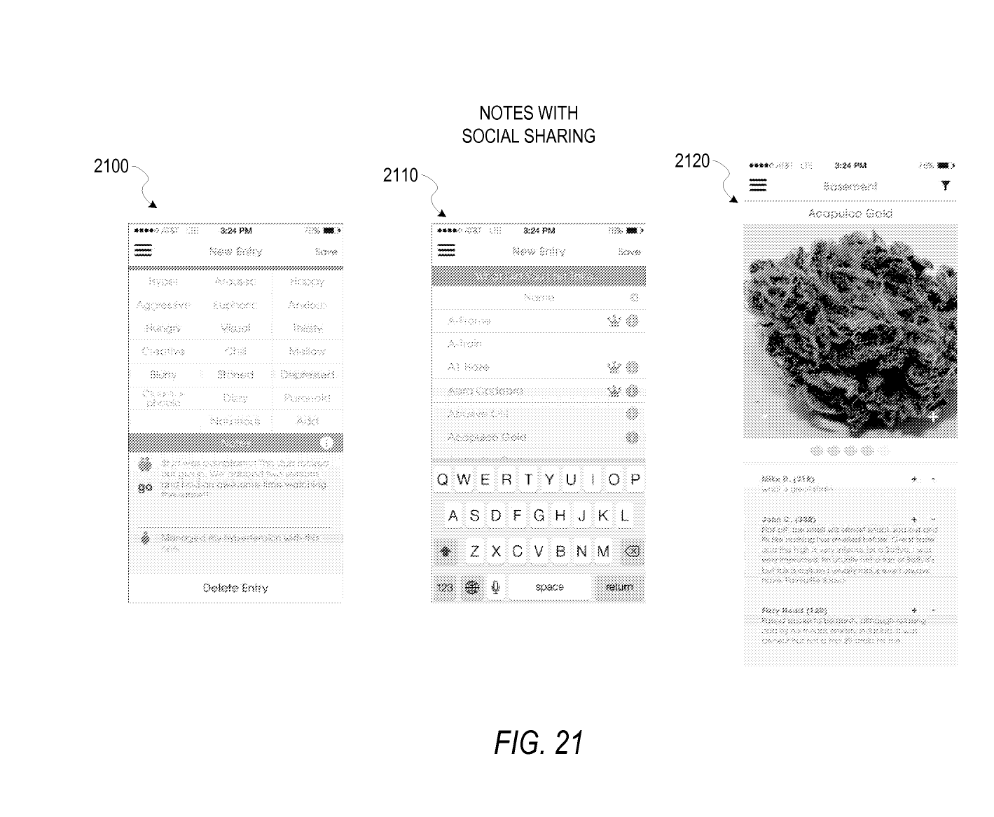

FIG. 21 depicts example UIs 2100, 2110, and 2120. Using these UIs, the user can publicly post comments pertaining to a particular consumable. These comments may be accessible to other users to assist other users in evaluating a particular consumable.

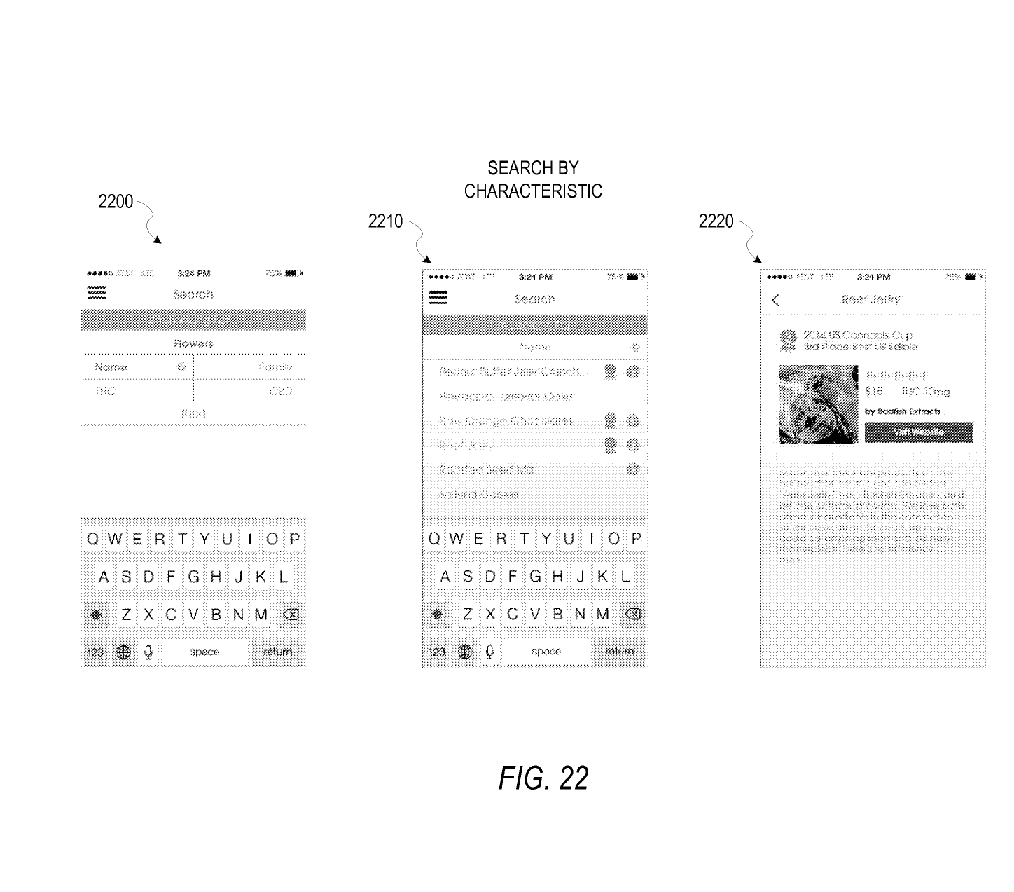

FIG. 22 depicts example UIs 2200, 2210, and 2220. The user can generate a query for a particular consumable based on consumable attributes or characteristics using these UIs. For example, the user can specify a particular consumable attribute (e.g., a concentration of an active ingredient) and view consumable that match or nearly match the specified consumable attribute.

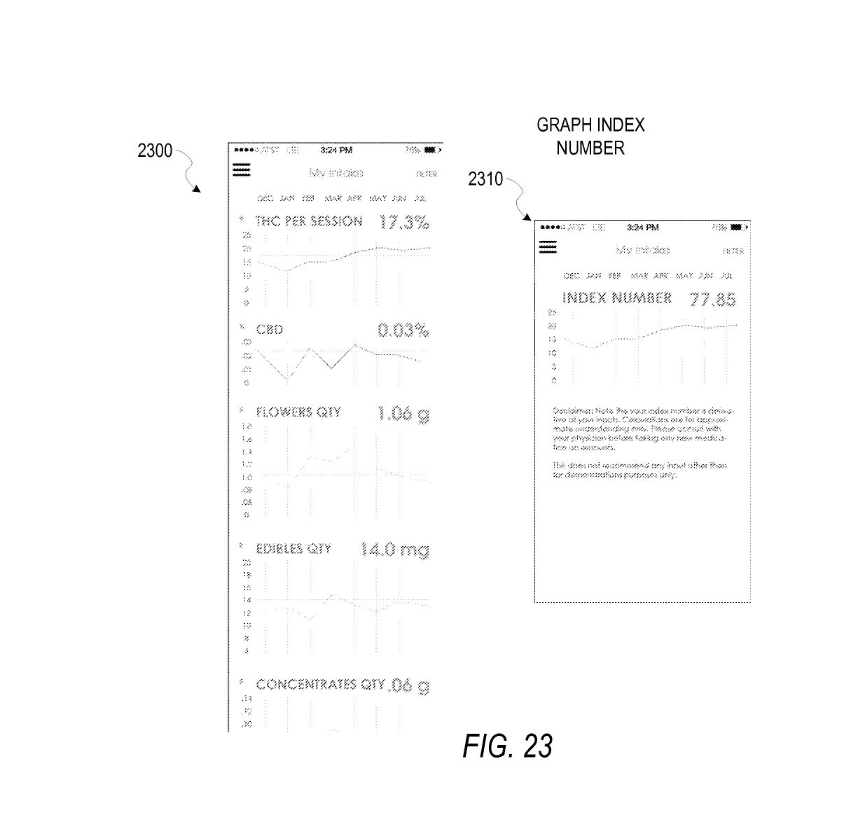

FIG. 23 depicts example UIs 2300 and 2310. These user interfaces provide the user with detailed information regarding their consumption history. The personalization system 160 can utilize such information to identify trends in the user consumption to enhance various recommendations.

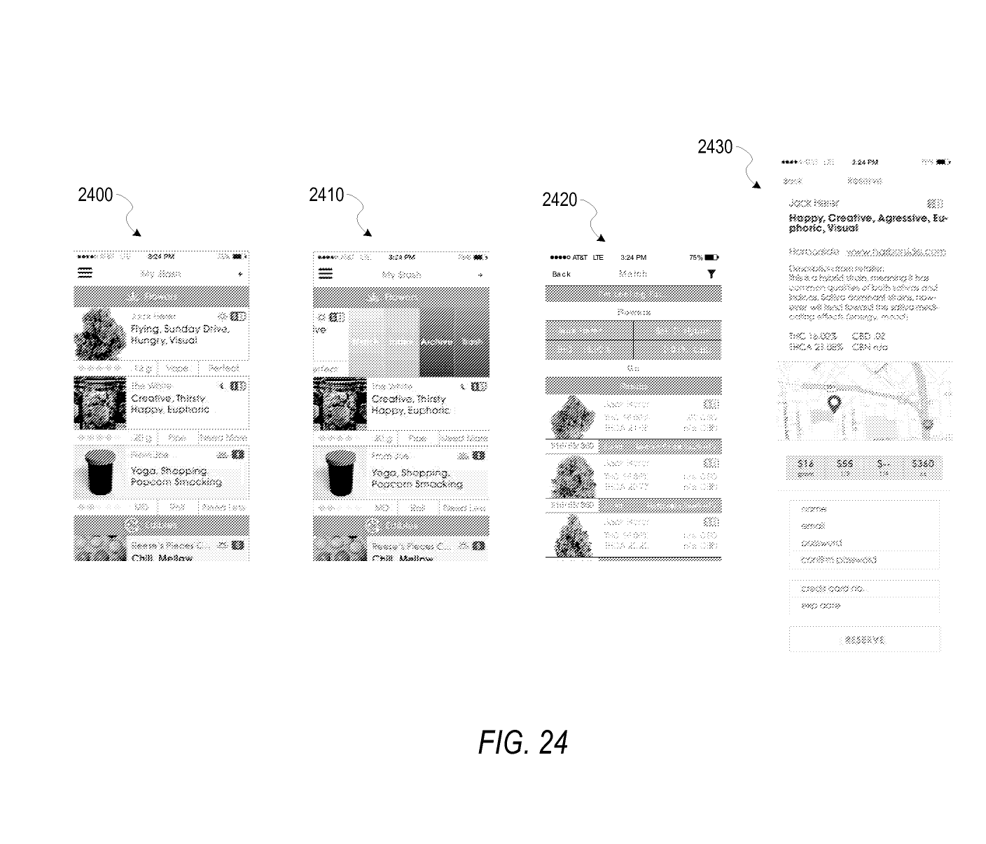

FIG. 24 depicts example UIs 2400, 2410, 2420, and 2430. These are example user interfaces for presenting consumable to the user. The consumables can be presented in a list ordered by category for example.

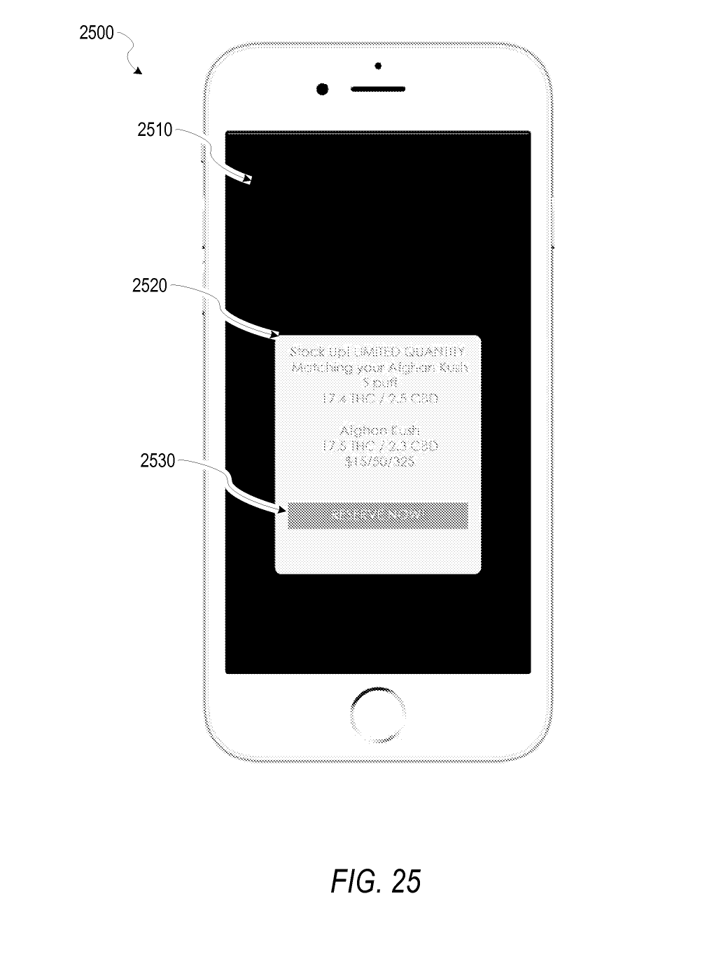

FIG. 25 depicts an example device 2500 (e.g., smart phone) displaying an example user interface 2510 that includes a notification 2520, according to some example embodiments. In various example embodiments, the presentation module 220 causes presentation of the notification 2520 to the user. For instance, the presentation module 220 communicates, to the device 2500, instructions to present the notification 2520. In some instances, the instructions include notification content, generated by the presentation module 220, such as a message (e.g., pertinent information) to be presented to the user. In example embodiments, the notification 2520 comprises a text message, such as Short Message Service (SMS) messages, Multimedia Messaging Service (MMS), Enhanced Messaging Service (EMS), and so forth. In other example embodiments, the notification 2520 comprises a push notification or another similar type of notification. In further example embodiments, the notification 2520 comprises interactive user interface elements such as user interface elements 2530. In these example embodiments, the user interface elements 2530 provide the user an option to make a selection (e.g., through an SMS system, mobile application). In some embodiments, the notification can be email or otherwise web based (e.g., a notification communicated within an online account of the user accessible to the user upon logging into the online account). In further embodiments, the communication module 210 communicates a portion of the notification via a particular modality while another portion of the notification is communicated using a different modality. For example, the communication module 210 can communicate pricing information for a particular consumable using a web based notification while availability is communicated using a push notification to the user device.

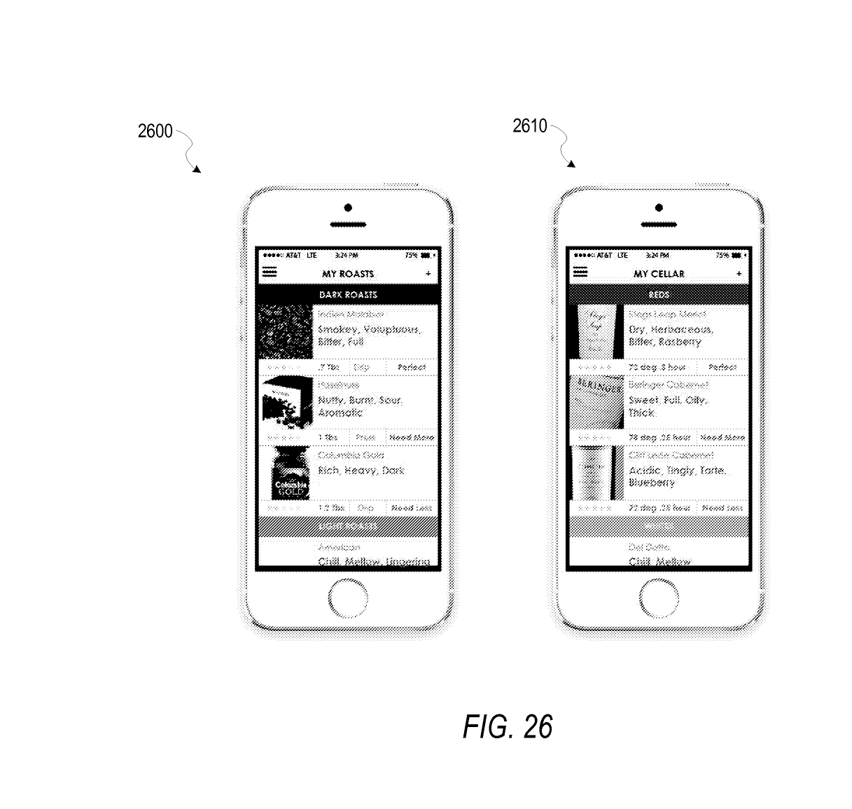

FIG. 26 depicts example UIs 2600 and 2610. These user interfaces depict consumable personalization for coffee and wine, although the systems and methods described herein can be employed to personalize a wide variety of other consumables.

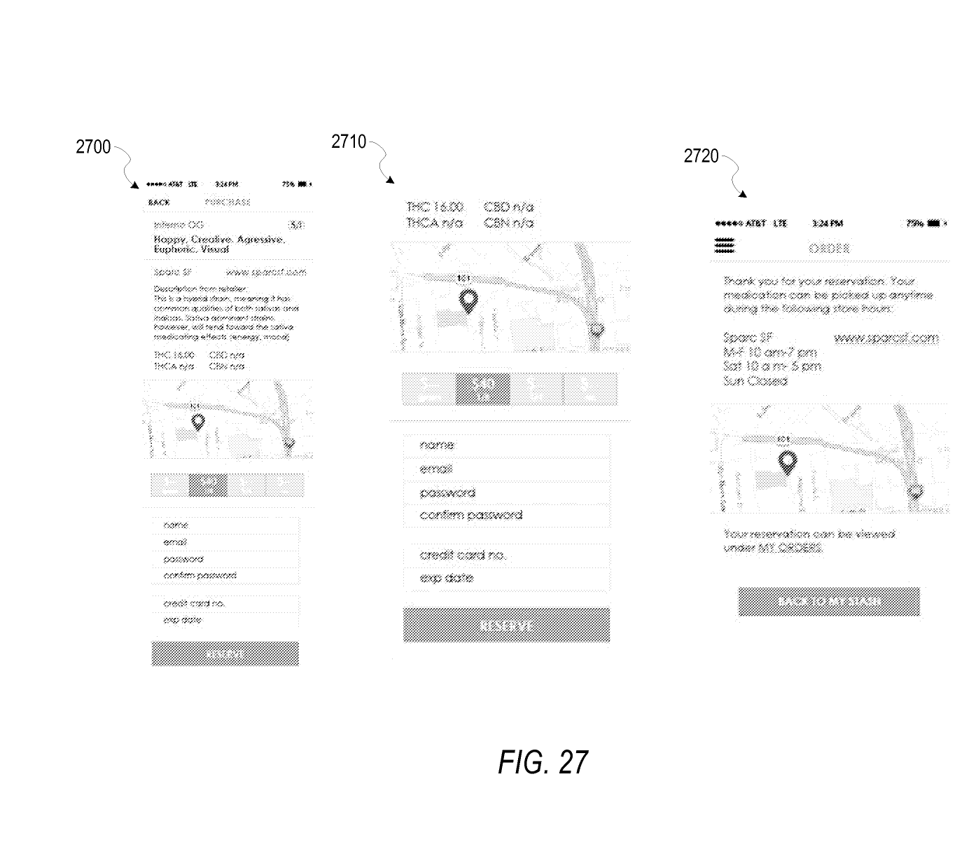

FIG. 27 depicts example UIs 2700, 2710, and 2720. In some embodiments, the personalization system 160 can facilitate a purchase of consumables. The UIs 2700, 2710, and 2720 provide the user with information to facilitate purchasing a consumable such as directions to a particular merchant, inventory available at a particular merchant, and an option to make a reservation for a particular consumable at a particular merchant.

FIG. 28A depicts example devices 2800 and 2810. In FIG. 28A, the device 2800 is a smart phone of the user communicatively coupled to the device 2810 that is a scale. Although FIG. 28A shows a wired connection between the measurement device and the user device, the measurement device can be communicatively coupled wirelessly to the user device or the personalization system 160 via, for example Bluetooth or a wireless network such as LTE. In this example, the device 2810 includes sensors operable to detect a consumption quantity of a consumable. The device 2180 can communicate detected consumption quantity to the device 2800 which in turn can communicate the detected consumption quantity to the personalization system 160. Although FIG. 28A depicts a scale, other devices can be employed to detect a consumption quantity.

FIG. 28B depicts example UIs 2820, 2830, and 2840. These user interfaces can be used to track smells of particular consumable. For example, in the UI 2830, the user can specify a smell descriptor such as menthol, spicy, minty, pine, citrus, floral, clove, pine, minty, peppery, floral, and so forth. In addition, in the UI 2820, the user can specify terpenes such as borneol, caryophyllene, cineole, delta3carene, limonene, linoloo, myrcene, pinene, pulegone, sabinene, terpineol. In some embodiments, the personalization system 160 converts, or translates, scientific classifications to user friendly descriptors to assist the user in describing a particular experience and allow for accurate logging of a particular experience. UI 2840 shows an example of presenting such descriptions to the user.

FIG. 28C depicts example user interfaces for logging of pain and pain relief associated with a particular consumption session. Such data can be used by the personalization system 160 to better provide recommendations to medical users seeking pain relief for specific areas of the body. FIG. 28D depicts example user interfaces for logging or tracking relief from certain mental states or conditions such as nausea or anxiety.

FIG. 28E depicts example user interfaces for tracking or logging a consumption session experience. The user can provide descriptions for smell and touch (e.g., textures such as sticky, crumbly, moist, dry, and so on). FIGS. 28F, 28G, and 28H depict example sensory information associated with a consumption session such as looks, smell, taste, and touch that the personalization system 160 tracks to improve recommendations.

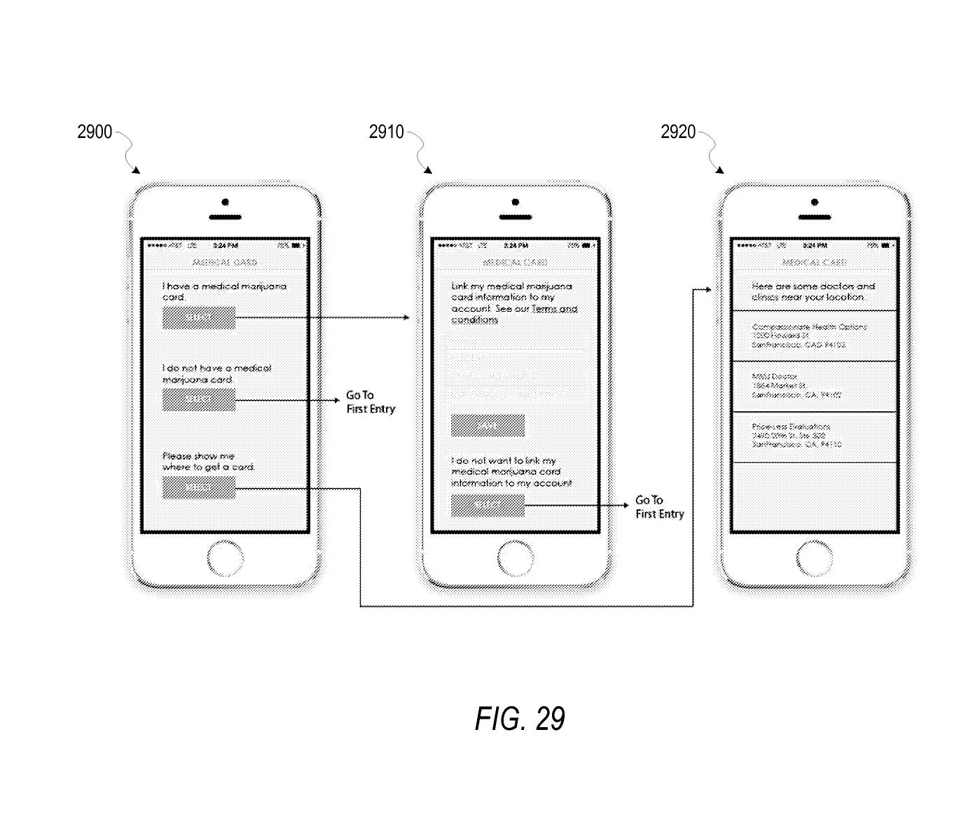

FIG. 29 depicts example UIs 2900, 2910, and 2920. These user interfaces further depict the personalization system 160 facilitating purchase of consumables. For cannabis-based consumables, a medical card may be needed to complete a purchase in some locations. In an example embodiment, the personalization system 160 can link the user's medical card to a user account allowing for a purchase of a cannabis-based consumable via the user account.

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications and so forth described in conjunction with FIG. 2 are implemented in some embodiments in the context of a machine and an associated software architecture. The sections below describe representative software architecture and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, and the like. Not all combinations of such software and hardware architectures are presented here as those of skill in the art can readily understand how to implement the invention in different contexts from the disclosure contained herein.

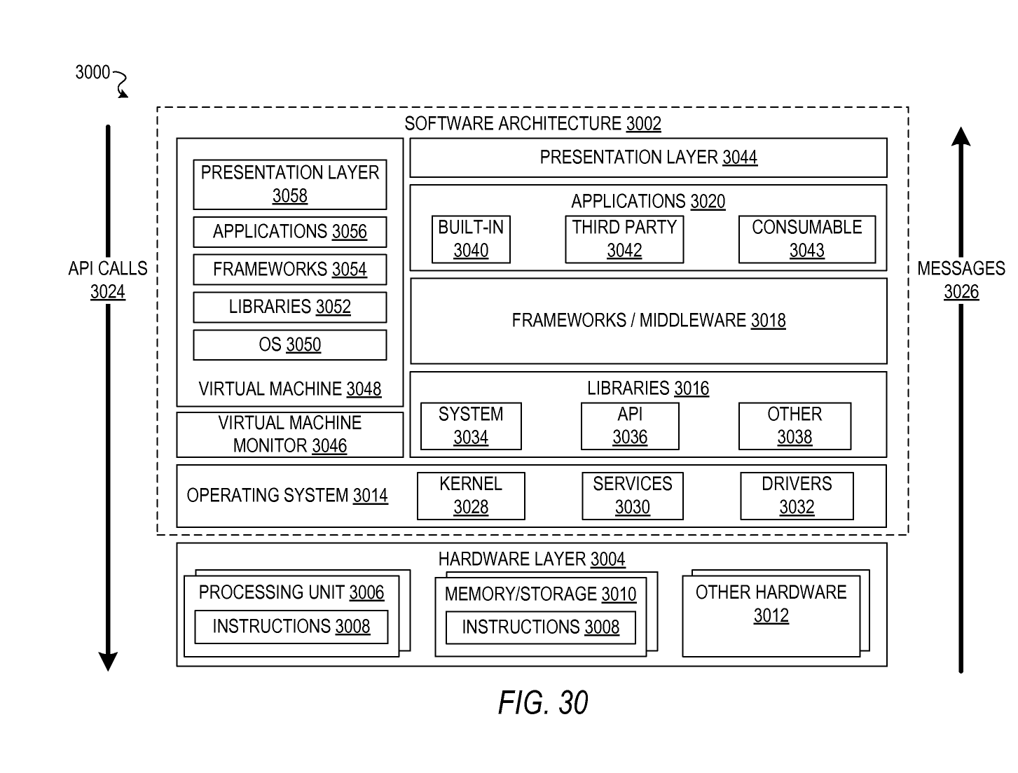

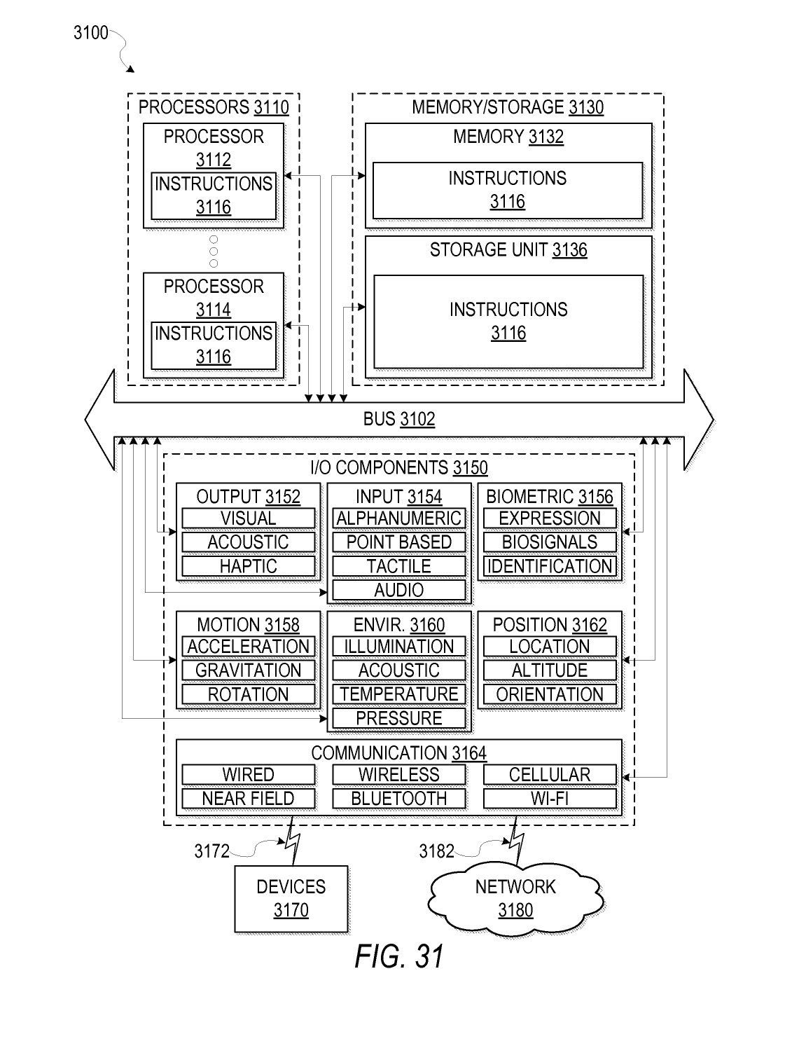

FIG. 30 is a block diagram 3000 illustrating a representative software architecture 3002, which may be used in conjunction with various hardware architectures herein described. FIG. 30 is merely a non-limiting example of a software architecture and it will be appreciated that many other architectures may be implemented to facilitate the functionality described herein. The software architecture 3002 may be executing on hardware such as machine 3100 of FIG. 31 that includes, among other things, processors 3110, memory/storage 3130, and I/O components 3150. A representative hardware layer 3004 is illustrated and can represent, for example, the machine 3100 of FIG. 31. The representative hardware layer 3004 comprises one or more processing units 3006 having associated executable instructions 3008. Executable instructions 3008 represent the executable instructions of the software architecture 3002, including implementation of the methods, modules and so forth of FIGS. 4 and 6-10. Hardware layer 3004 also includes memory and storage modules 3010, which also have executable instructions 3008. Hardware layer 3004 may also comprise other hardware as indicated by 3012 which represents any other hardware of the hardware layer 3004, such as the other hardware illustrated as part of machine 3100.

In the example architecture of FIG. 30, the software 3002 may be conceptualized as a stack of layers where each layer provides particular functionality. For example, the software 3002 may include layers such as an operating system 3014, libraries 3016, frameworks/middleware 3018, applications 3020 and presentation layer 3022. Operationally, the applications 3020 or other components within the layers may invoke application programming interface (API) calls 3024 through the software stack and receive a response, returned values, and so forth illustrated as messages 3026 in response to the API calls 3024. The layers illustrated are representative in nature and not all software architectures have all layers. For example, some mobile or special purpose operating systems may not provide the frameworks/middleware layer 3018, while others may provide such a layer. Other software architectures may include additional or different layers.

The operating system 3014 may manage hardware resources and provide common services. The operating system 3014 may include, for example, a kernel 3028, services 3030, and drivers 3032. The kernel 3028 may act as an abstraction layer between the hardware and the other software layers. For example, the kernel 3028 may be responsible for memory management, processor management (e.g., scheduling), component management, networking, security settings, and so on. The services 3030 may provide other common services for the other software layers. The drivers 3032 may be responsible for controlling or interfacing with the underlying hardware. For instance, the drivers 3032 may include display drivers, camera drivers, BLUETOOTH® drivers, flash memory drivers, serial communication drivers (e.g., Universal Serial Bus (USB) drivers), WI-FI® drivers, audio drivers, power management drivers, and so forth depending on the hardware configuration.

The libraries 3016 may provide a common infrastructure that may be utilized by the applications 3020 or other components or layers. The libraries 3016 typically provide functionality that allows other software modules to perform tasks in an easier fashion than to interface directly with the underlying operating system 3014 functionality (e.g., kernel 3028, services 3030 or drivers 3032). The libraries 3016 may include system 3034 libraries (e.g., C standard library) that may provide functions such as memory allocation functions, string manipulation functions, mathematic functions, and the like. In addition, the libraries 3016 may include API libraries 3036 such as media libraries (e.g., libraries to support presentation and manipulation of various media format such as MPREG4, H.264, MP3, AAC, AMR, JPG, or PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 3016 may also include a wide variety of other libraries 3038 to provide many other APIs to the applications 3020 and other software components/modules.

The frameworks 3018 (also sometimes referred to as middleware) may provide a higher-level common infrastructure that may be utilized by the applications 3020 or other software components/modules. For example, the frameworks 3018 may provide various graphic user interface (GUI) functions, high-level resource management, high-level location services, and so forth. The frameworks 3018 may provide a broad spectrum of other APIs that may be utilized by the applications 3020 or other software components/modules, some of which may be specific to a particular operating system or platform.

The applications 3020 include built-in applications 3040, third party applications 3042, or a consumable application 3043 that can implement a portion of the personalization system 160. Examples of representative built-in applications 3040 may include, but are not limited to, a contacts application, a browser application, a book reader application, a location application, a media application, a messaging application, or a game application. Third party applications 3042 may include any of the built-in applications as well as a broad assortment of other applications. In a specific example, the third party application 3042 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or other mobile operating systems. In this example, the third party application 3042 may invoke the API calls 3024 provided by the mobile operating system such as operating system 3014 to facilitate functionality described herein.

The applications 3020 may utilize built-in operating system functions (e.g., kernel 3028, services 3030 or drivers 3032), libraries (e.g., system 3034, APIs 3036, and other libraries 3038), frameworks/middleware 3018 to create user interfaces to interact with users of the system. Alternatively, or additionally, in some systems interactions with a user may occur through a presentation layer, such as presentation layer 3044. In these systems, the application/module “logic” can be separated from the aspects of the application/module that interact with a user.

Some software architectures utilize virtual machines. In the example of FIG. 30, this is illustrated by virtual machine 3048. A virtual machine creates a software environment where applications/modules can execute as if they were executing on a hardware machine (such as the machine of FIG. 31, for example). A virtual machine is hosted by a host operating system (operating system 3014 in FIG. 31) and typically, although not always, has a virtual machine monitor 3046, which manages the operation of the virtual machine as well as the interface with the host operating system (i.e., operating system 3014). A software architecture executes within the virtual machine such as an operating system 3050, libraries 3052, frameworks/middleware 3054, applications 3056 or presentation layer 3058. These layers of software architecture executing within the virtual machine 3048 can be the same as corresponding layers previously described or may be different.

FIG. 31 is a block diagram illustrating components of a machine 3100, according to some example embodiments, able to read instructions from a machine-Attorney readable medium (e.g., a machine-readable storage medium) and perform any one or more of the methodologies discussed herein. Specifically, FIG. 31 shows a diagrammatic representation of the machine 3100 in the example form of a computer system, within which instructions 3116 (e.g., software, a program, an application, an applet, an app, or other executable code) for causing the machine 3100 to perform any one or more of the methodologies discussed herein can be executed. For example, the instruction can cause the machine to execute the flow diagrams of FIGS. 4 and 6-10. Additionally, or alternatively, the instruction can implement the communication module 210, the presentation module 220, the match module 230, the dosage module 240, or the data module 250 of FIG. 2, and so forth. The instructions transform the general, non-programmed machine into a particular machine programmed to carry out the described and illustrated functions in the manner described. In alternative embodiments, the machine 3100 operates as a standalone device or can be coupled (e.g., networked) to other machines. In a networked deployment, the machine 3100 may operate in the capacity of a server machine or a client machine in a server-client network environment, or as a peer machine in a peer-to-peer (or distributed) network environment. The machine 3100 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 3116, sequentially or otherwise, that specify actions to be taken by the machine 3100. Further, while only a single machine 3100 is illustrated, the term “machine” shall also be taken to include a collection of machines 3100 that individually or jointly execute the instructions 3116 to perform any one or more of the methodologies discussed herein.

The machine 3100 can include processors 3110, memory/storage 3130, and I/O components 3150, which can be configured to communicate with each other such as via a bus 3102. In an example embodiment, the processors 3110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 3112 and processor 3114 that may execute instructions 3116. The term “processor” is intended to include multi-core processor that may comprise two or more independent processors (sometimes referred to as “cores”) that can execute instructions contemporaneously. Although FIG. 31 shows multiple processors, the machine 3100 may include a single processor with a single core, a single processor with multiple cores (e.g., a multi-core processor), multiple processors with a single core, multiple processors with multiples cores, or any combination thereof.

The memory/storage 3130 can include a memory 3132, such as a main memory, or other memory storage, and a storage unit 3136, both accessible to the processors 3110 such as via the bus 3102. The storage unit 3136 and memory 3132 store the instructions 3116 embodying any one or more of the methodologies or functions described herein. The instructions 3116 can also reside, completely or partially, within the memory 3132, within the storage unit 3136, within at least one of the processors 3110 (e.g., within the processor's cache memory), or any suitable combination thereof, during execution thereof by the machine 3100. Accordingly, the memory 3132, the storage unit 3136, and the memory of the processors 3110 are examples of machine-readable media.

As used herein, the term “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 3116. The term “machine-readable medium” shall also be taken to include any medium, or combination of multiple media, that is capable of storing instructions (e.g., instructions 3116) for execution by a machine (e.g., machine 3100), such that the instructions, when executed by one or more processors of the machine 3100 (e.g., processors 3110), cause the machine 3100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 3150 can include a wide variety of components to receive input, provide output, produce output, transmit information, exchange information, capture measurements, and so on. The specific I/O components 3150 that are included in a particular machine will depend on the type of machine. For example, portable machines such as mobile phones will likely include a touch input device or other such input mechanisms, while a headless server machine will likely not include such a touch input device. It will be appreciated that the I/O components 3150 can include many other components that are not shown in FIG. 31. The I/O components 3150 are grouped according to functionality merely for simplifying the following discussion and the grouping is in no way limiting. In various example embodiments, the I/O components 3150 can include output components 3152 and input components 3154. The output components 3152 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 3154 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 3150 can include biometric components 3156, motion components 3158, environmental components 3160, or position components 3162 among a wide array of other components. For example, the biometric components 3156 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 3158 can include acceleration sensor components (e.g., an accelerometer), gravitation sensor components, rotation sensor components (e.g., a gyroscope), and so forth. The environmental components 3160 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 3162 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 3150 may include communication components 3164 operable to couple the machine 3100 to a network 3180 or devices 3170 via a coupling 3182 and a coupling 3172, respectively. For example, the communication components 3164 include a network interface component or other suitable device to interface with the network 3180. In further examples, communication components 3164 include wired communication components, wireless communication components, cellular communication components, Near Field Communication (NFC) components, BLUETOOTH® components (e.g., BLUETOOTH® Low Energy), WI-FED components, and other communication components to provide communication via other modalities. The devices 3170 may be another machine or any of a wide variety of peripheral devices (e.g., a peripheral device coupled via a Universal Serial Bus (USB)).

Moreover, the communication components 3164 can detect identifiers or include components operable to detect identifiers. For example, the communication components 3164 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 3164, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 3180 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 3180 or a portion of the network 3180 may include a wireless or cellular network, and the coupling 3182 may be a Code Division Multiple Access (CDMA) connection, a Global System for Mobile communications (GSM) connection, or other type of cellular or wireless coupling. In this example, the coupling 3182 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 3116 can be transmitted or received over the network 3180 using a transmission medium via a network interface device (e.g., a network interface component included in the communication components 3164) and utilizing any one of a number of well-known transfer protocols (e.g., Hypertext Transfer Protocol (HTTP)). Similarly, the instructions 3116 can be transmitted or received using a transmission medium via the coupling 3172 (e.g., a peer-to-peer coupling) to devices 3170. The term “transmission medium” shall be taken to include any intangible medium that is capable of storing, encoding, or carrying the instructions 3116 for execution by the machine 3100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, from a user device of a user, a request to identify similar consumables that are similar to a first consumable;
accessing consumable data corresponding to a plurality of consumables, the consumable data including attributes of respective consumables of the plurality of consumables, the attributes including potency data for a first active ingredient;
identifying, using a hardware processor of a machine, a second consumable among the plurality of consumables by comparing attributes of the first consumable with the attributes of the respective consumables of the plurality of consumables; and
causing presentation of the second consumable on a user interface of the user device.

2. The method of claim 1, further comprising:
receiving an indication of a consumption quantity corresponding to the first consumable from the user device;
calculating a consumption score for the first consumable based on the consumption quantity corresponding to the first consumable and potency data for the first consumable;
determining a recommended consumption quantity for the second consumable based on the consumption score for the first consumable and the potency data for the second consumable; and
causing presentation of the recommended consumption quantity on the user interface of the user device.

3. The method of claim 2, wherein the consumption score is based on a ratio of potency data for the first active ingredient and a second active ingredient of the first consumable.

4. The method of claim 2, wherein the consumption quantity corresponding to the first consumable is received from a consumption measurement device having a sensor to detect the consumption quantity for a particular consumption session.

5. The method of claim 1, further comprising identifying a similar user from among a plurality of users that is similar to the user, the similar user being identified based on user data of the user and user data of the similar user; and
wherein the identifying the second consumable is further based on the user data of the identified similar user.

6. The method of claim 1, further comprising receiving, from the user device, an indication of a user activity of the user; and
wherein the identifying the second consumable is further based, in part, on the user activity of the user.

7. The method of claim 1, further comprising:
accessing inventory data of a third party for the second consumable from a third party server, the inventory data indicating an inventory level of the second consumable; and
causing presentation of a notification indicating the inventory level on the user interface of the user device.

8. The method of claim 1, wherein the request is received in response to the user device detecting the indication of the first consumable, wherein the user device detects the indication of the first consumable by at least one of an Optical Character Recognition (OCR) or a bar code scan associated with the first consumable.

9. The method of claim 1, wherein the request is received in response to a touch-based gesture corresponding to the first consumable, wherein the touch-based gesture is a swipe, by the user, across a touch screen surface of the user device.

10. The method of claim 1, further comprising:
accessing chemical composition data of the second consumable;
converting a scientific name included in the chemical composition data to a commonplace name; and
causing presentation of the commonplace name on the user interface of the user device.

11. A system comprising:
a communication module to receive, from a user device of a user, a request to identify similar consumables that are similar to a first consumable;
a data module to access consumable data that corresponds to a plurality of consumables, the consumable data including attributes of respective consumables of the plurality of consumables, the attributes including potency data for a first active ingredient;
a match module, implemented by at least one hardware processor of a machine, to identify a second consumable among the plurality of consumables by comparing attributes of the first consumable with the attributes of the respective consumables of the plurality of consumables; and
a presentation module to cause presentation of the second consumable on a user interface of the user device.

12. The system of claim 11,
wherein the communication module is further to receive an indication of a consumption quantity corresponding to the first consumable from the user device;
the system further comprising a dosage module to:
calculate a consumption score for the first consumable based on the consumption quantity corresponding to the first consumable and potency data for the first consumable;
determine a recommended consumption quantity for the second consumable based on the consumption score for the first consumable and the potency data for the second consumable; and
wherein the presentation module is further to cause presentation of the recommended consumption quantity on the user interface of the user device.

13. The system of claim 12, wherein the consumption score is based on a ratio of potency data for the first active ingredient and a second active ingredient of the first consumable.

14. The system of claim 12, wherein the consumption quantity corresponding to the first consumable is received from a consumption measurement device having a sensor to detect the consumption quantity for a particular consumption session.

15. A machine-readable medium having no transitory signals and storing instructions that, when executed by at least one processor of a machine, cause the machine to perform operations comprising:
receiving, from a user device of a user, a request to identify similar consumables that are similar to a first consumable;
accessing consumable data corresponding to a plurality of consumables, the consumable data including attributes of respective consumables of the plurality of consumables, the attributes including potency data for a first active ingredient;
identifying a second consumable among the plurality of consumables by comparing attributes of the first consumable with the attributes of the respective consumables of the plurality of consumables; and
causing presentation of the second consumable on a user interface of the user device.

16. The machine-readable medium of claim 15, wherein the operations further comprise:
receiving an indication of a consumption quantity corresponding to the first consumable from the user device;
calculating a consumption score for the first consumable based on the consumption quantity corresponding to the first consumable and potency data for the first consumable;
determining a recommended consumption quantity for the second consumable based on the consumption score for the first consumable and the potency data for the second consumable; and
causing presentation of the recommended consumption quantity on the user interface of the user device.

17. The machine-readable medium of claim 16, wherein the consumption score is based on a ratio of potency data for the first active ingredient and a second active ingredient of the first consumable.

18. The machine-readable medium of claim 16, wherein the consumption quantity corresponding to the first consumable is received from a consumption measurement device having a sensor to detect the consumption quantity for a particular consumption session.

19. The machine-readable medium of claim 15, further comprising
identifying a similar user from among a plurality of users that is similar to the user, the similar user being identified based on user data of the user and user data of the similar user; and
wherein the identifying the second consumable is further based on the user data of the identified similar user.

20. The machine-readable medium of claim 15, further comprising receiving, from the user device, an indication of a user activity of the user; and
wherein the identifying the second consumable is further based, in part, on the user activity of the user.
